(19) United States
(12) Patent Application Publication
(10) Pub. No.: US 2019/0311582 A1
(43) Pub. Date: Oct. 10, 2019

(54) SYSTEMS FOR A MAZE CHASE HYBRID GAME

(71) Applicant: Gamblit Gaming, LLC, Glendale, CA (US)

(72) Inventors: Miles Arnone, Cambridge, MA (US); David Chang, San Gabriel, CA (US); Frank Cire, Pasadena, CA (US); Caitlyn Ross, Watertown, MA (US)

(21) Appl. No.: 16/449,251

(22) Filed: Jun. 21, 2019

Related U.S. Application Data
(63) Continuation-in-part of application No. 15/667,168, filed on Aug. 2, 2017, now abandoned.
Application No. 15/667,168 is a continuation of application No. 14/617,852, filed on Feb. 9, 2015, now abandoned.
Application No. 14/617,852 is a continuation of application No. PCT/US2013/054033, filed on Aug. 7, 2013.
(60) Provisional application No. 61/680,369, filed on Aug. 7, 2012.

(51) Int. Cl. G07F 17/32

(52) U.S. Cl. CPC G07F 17/3295; G07F 17/3279; G07F 17/3211; G07F 17/3274; G07F 17/3267; G07F 17/3244; G07F 17/3227; G07F 17/3223; G07F 17/3262

(57) ABSTRACT

An electromechanical gaming system for a maze chase hybrid game system, including an entertainment system engine constructed to: provide an entertainment game; display a first icon in a user interface of the entertainment game; communicate an indication when the first icon is consumed; display a second icon, different in appearance from the first icon; communicate the second icon is consumed; a real world engine constructed to: receive the wager of real credits; and communicate the wager outcome of real credits; and the game world engine connected to the entertainment system engine and the real world engine using a communication link, and constructed to: receive the indication when the first icon is consumed; communicate the wager of real credits; receive the indication when the second icon is consumed; and communicate the random outcome of in-game objects.

### CROSS-REFERENCE TO RELATED APPLICATIONS

The current application is a continuation in part of U.S. patent application Ser. No. 15/667,168, filed on Aug. 2, 2017 which is a continuation of U.S. patent application Ser. No. 14/617,852, filed on Feb. 9, 2015 which is a continuation of Patent Cooperation Treaty Application No. PCT/US2013/54033, filed Aug. 7, 2013, which claims the benefit of U.S. Provisional Application No. 61/680,369, filed Aug. 7, 2012, the disclosures of each of which are incorporated herein by reference as if set forth herein.

### FIELD OF THE INVENTION

Embodiments of the invention are generally related to data processing systems. More particularly, embodiments of the invention relate to data processing systems that implement hybrid chase game wagering processes.

### BACKGROUND OF THE INVENTION

The gaming machine manufacturing industry has traditionally developed gaming machines with a simple gambling game. A simple gambling game is a game of chance where the outcome of the game is dependent solely on chance (such as a slot machine). A game of chance can be contrasted with a game of skill where the outcome of the game may depend upon a player's skill with the game. Simple gambling games are not as interactive and do not include graphics as sophisticated as an entertainment game, which may be a game of skill such as a video game.

FIG. 20A illustrates operations of a prior art simple gaming device 2000 as described in U.S. Pat. No. 6,905,405 issued to McClintic. The gaming device is provided with a central processor (CPU) operably coupled to controlling software memory, which includes assigned memory locations storing game software and system software. Such controlling software memory dictates when selected graphics or messages are displayed to a player, as well as when play sequences begin and end and management of wager input and award output. The CPU is also operably coupled to a second memory 2002, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a player activates an initiator element such as a handle, a physical button or a touch screen to initiate a play sequence. At this point, the game software, in conjunction with a random number generator 2004, generates 2006 a random symbol configuration at for a random final outcome comprised of a pattern of symbols for depiction on video monitor. System software then animates 2008 the video monitor by simulating the movement of visible representations of symbol carriers including symbols thereon so that the player perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared 2010 with data stored in game software representing winning combinations to determine if any displayed combination on an active pay line is a winning combination. Any identified winning combination or combinations of symbols are then associated with winnings to be distributed to the player according to a paytable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Such a simple gaming device is capable of implementing an electronic version of 3-reel slot machine having 22 possible positions or symbols on each reel. In such a simple game, there are 22\hat{ }3, or 10,648, possible pays based on the combinations of the reel positions. Each time the gaming device is played, a single pay is determined from randomly “spinning” the reels. If a 3-reel slot machine is implemented on the simple gaming device having virtual video reels, each possible pay is explicitly enumerated and stored in second memory 2002 that is used to store a pay as well as store a final reel position indicating the final position of each reel after each reel as been “spun”. Such a table will have at least 10,648 locations with one location for each possible combination of the 3 reels, with each location storing a pay and a symbol combination of the 3 reels, commonly termed a game feature. If digital storage of each game feature requires 8 bytes of storage, the table can be stored in approximately 83 kilobytes of digital memory (8 bytes of data for each pay and symbol combination identifier×10,648 possible pays/1024 Bytes per kilobyte). Accordingly, approximately 83 kilobytes of memory is needed to store all of the enumerated pay and symbol combinations that correspond to the game features of a simple slot machine game having approximately 10 thousand (10,000) game features. However, some complex wagering processes have approximately 1 sextillion (1,000,000,000,000,000,000,000) game features. Such a complex wagering process may not be implementable on a simple gaming device because of the memory requirements.

FIG. 20B illustrates operation of a simple gaming system as described in U.S. Pat. No. 6,409,602 issued to Wiltshire et al. A game program 2024 is executed on server/host computer 2020. It is then determined whether an image is to be displayed on a screen of a client/terminal computer 2022. If so, an image 2026 is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways 2028 to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal.

In such a simple gaming system, all images of the wagering game are generated on the server/host and then all of the images are transferred to the client/terminal. This limits the complexity of the interactions by the player with a wagering game hosted by the server/host because of the time required to communicate the images between the server/host and as well as network lag in requesting the transfer of the images. A complex wagering game cannot be implemented on such a simple gaming system.

Accordingly, a need exists for gaming systems that can implement complex wagering processes as simple gaming devices may not be able to access enough memory to store enough game features to implement a complex wagering process and a simple gaming system may not be able to transfer an amount of images required by a complex wagering process. Various aspects and embodiments of the invention meet such a need.

### SUMMARY OF THE INVENTION

Systems in accordance with some embodiments of the invention provide a maze chase hybrid game system.

In an embodiment, a gaming system for a hybrid maze chase game includes an entertainment system engine connected to a game world engine, wherein the entertainment software engine is constructed to provide a skill-based entertainment game to a player, generate a visual display of the entertainment game including a user interface, display a first icon in the user interface of the entertainment game, communicate, to a game world engine, an indication when the first icon is consumed by a controlled entity during the entertainment game, wherein the first icon consumption initiates a wager of real credits, receive, from the game world engine, a wager outcome of real credits, update the visual display of the entertainment game to include the wager outcome, generate, in the entertainment game, a first set of in-game objects associated with the wager outcome, display a second icon, different in appearance from the first icon, in the user interface of the entertainment game, communicate, to the game world engine, an indication when the second icon is consumed by the controlled entity during the entertainment game, wherein the second icon consumption initiates a random outcome, receive, from the game world engine, the random outcome, update the visual display of the entertainment game to include the random outcome, and generate, in the entertainment game, a second set of in-game objects associated with the random outcome. The system further includes the real world engine connected to the game world engine, wherein the real world engine includes a random number generator and is constructed to receive, from the game world engine, the wager of real credits, generate the wager outcome of real credits using the random number generator, and communicate, to the game world engine, the wager outcome. The system further includes the game world engine connected to the entertainment system engine and the real world engine constructed to receive, from the entertainment system engine, the indication when the first icon is consumed, communicate, to the real world engine, the wager of real credits, receive, from the real world engine, the wager outcome, determine the first set of in-game objects for the entertainment game associated with the wager outcome, communicate, to the entertainment system engine, the first set of in-game objects for the entertainment game associated with the wager outcome, receive, from the entertainment system engine, the indication when the second icon is consumed, generate the random outcome, determine the second set of in-game objects for the entertainment game associated with the random outcome, and communicate, to the entertainment system engine, the second set of in-game objects for the entertainment game associated with the random outcome.

In an additional embodiment, an entertainment system engine is further constructed to display a first random event process indicator in the user interface of the entertainment game when the first icon is consumed by the controlled entity, and display a second random event process indicator in the user interface of the entertainment game when the second icon is consumed by the controlled entity, wherein the first random event process indicator and the second random event process indicator are different in appearance.

In an additional embodiment, the entertainment system engine is further constructed to display a first random event outcome indicator in the user interface of entertainment game when the first icon is consumed by the controlled entity, and display a second random event outcome indicator in the user interface of the entertainment game when the second icon is consumed by the controlled entity, wherein the first random event outcome indicator and the second random event outcome indicator are different in appearance.

In another embodiment, initiating the random outcome also initiates a wager of game world credits.

In another embodiment, game world credit is awarded as a function of performance in the entertainment game.

In another embodiment, initiating the wager further includes determining the amount of real credit committed to the wager.

In another embodiment, the in-game objects provide additional opportunities to control the controlled entity.

In another embodiment, the entertainment software engine, the real world engine, and the game world engine are constructed from a singe device.

In another embodiment, the entertainment software engine, the real world engine, and the game world engine are constructed from a plurality of devices.

In an embodiment, a gaming system for a hybrid maze chase game, includes a processor, a random number generator, and a memory connected to the processor, wherein the memory stores executable instructions that when executed by the processor cause the processor to provide a skill-based entertainment game to a player, generate a visual display of the entertainment game including a user interface, display a first icon in the user interface of the entertainment game, determine when the first icon is consumed by a controlled entity during the entertainment game, wherein the first icon consumption initiates a wager of real credits, determine a wager outcome of real credits for the wager of real credits using the random number generator, update the visual display of the entertainment game to include the wager outcome, generate, in the entertainment game, a first set of in-game objects associated with the wager outcome, display a second icon, different in appearance from the first icon, in the user interface of the entertainment game, determine when the second icon is consumed by the controlled entity during the entertainment game, wherein the second icon consumption initiates a random outcome, update the visual display of the entertainment game to include the random outcome; and generate, in the entertainment game, a second set of in-game objects associated with the random outcome.

Another embodiment of the maze chase hybrid game system includes an entertainment system engine constructed to: provide an entertainment game; display a first icon in a user interface of the entertainment game; communicate, to the game world engine, an indication when the first icon is consumed by a controlled entity of the entertainment game during skillful play of the entertainment game, wherein the first icon consumption initiates a wager of real credits having an outcome of real credits; display a second icon, different in appearance from the first icon, in the user interface of the entertainment game; communicate, to the game world engine, an indication when the second icon is consumed by the controlled entity of the entertainment game during skillful play of the entertainment game, wherein the second icon consumption initiates a random outcome of in-game objects for the entertainment game; a real world engine constructed to: receive, from a game world engine, the wager of real credits; and communicate, to the game world engine, the wager outcome of real credits; and the game world engine connected to the entertainment system engine and the real world engine using a communication link, and constructed to: receive, from the entertainment system engine, the indication when the first icon is consumed; communicate, to the real world engine, the wager of real credits; receive, from the real world engine, the wager outcome; receive, from the entertainment system engine, the indication when the second icon is consumed; and communicate, to the entertainment system engine, the random outcome of in-game objects for the entertainment game.

In a further embodiment, the entertainment system engine is further constructed to: display a first random event process indicator in the user interface of the entertainment game in the case the first icon is consumed by the controlled entity; and display a second random event process indicator in the user interface of the entertainment game in the case the second icon is consumed by the controlled entity, wherein the first random event process indicator and the second random event process indicator are different in appearance.

In a further embodiment, the entertainment system engine is further constructed to: display a first random event outcome indicator in the user interface of entertainment game in the case the first icon is consumed by the controlled entity; and display a second random event outcome indicator in the user interface of the entertainment game in the case the second icon is consumed by the controlled entity, wherein the first random event outcome indicator and the second random event outcome indicator are different in appearance.

In a further embodiment, initiating the random outcome of in-game objects for the entertainment game comprises making a wager of game world credits.

In a further embodiment, game world credit is awarded as a function of performance in the entertainment game.

In a further embodiment, the in-game objects comprise game world credits.

In a further embodiment, the in-game objects comprise additional opportunities to control the controlled entity.

An embodiment of the maze chase hybrid game system includes an entertainment system engine constructed to: provide an entertainment game; display a first icon in a user interface of the entertainment game; communicate, to the game world engine, an indication when the first icon is consumed by a controlled entity of the entertainment game during skillful play of the entertainment game, wherein the first icon consumption initiates a wager of real credits having a wager outcome of real credits; display a second icon, different in appearance from the first icon, in the user interface of the entertainment game; and communicate, to the game world engine, an indication when the second icon is consumed by the controlled entity of the entertainment game during skillful play of the entertainment game, wherein the second icon consumption initiates a random outcome of in-game objects for the entertainment game; and the game world engine connected to the entertainment system engine and a real world engine using a communication link, and constructed to: receive, from the entertainment system engine, the indication when the first icon is consumed; communicate, to the real world engine, the wager of real credits; receive, from the real world engine, the wager outcome; receive, from the entertainment system engine, the indication when the second icon is consumed; and communicate, to the entertainment system engine, the random outcome of in-game objects for the entertainment game.

An embodiment of the maze chase hybrid game system includes a real world engine constructed to: receive, from a game world engine, a wager of real credits; and communicate, to the game world engine, a wager outcome of real credits; and the game world engine connected to an entertainment system engine and the real world engine using a communication link, and constructed to: receive, from the entertainment system engine displaying a first icon in a user interface of an entertainment game, an indication when the first icon is consumed by a controlled entity of the entertainment game during skillful play of the entertainment game; communicate, to the real world engine, the wager of real credits; receive, from the real world engine, the wager outcome; receive, from the entertainment system engine displaying a second icon, different in appearance from the first icon, in the user interface of the entertainment game, an indication when the second icon is consumed by the controlled entity of the entertainment game during skillful play of the entertainment game; and communicate, to the entertainment system engine, a random outcome of in-game objects for the entertainment game.

### BRIEF DESCRIPTION OF THE DRAWINGS

FIG. 1A is block diagram of a maze chase hybrid game system in accordance with various embodiments of the invention.

FIG. 1B illustrates a conceptual diagram of components of a maze chase hybrid game system in accordance with an embodiment of the invention.

FIG. 2 illustrates a conceptual diagram of embodiments of a Real World Engine (RWE) of a maze chase hybrid game system in accordance with some embodiments of the invention.

FIG. 3 illustrates a conceptual diagram of embodiments of a Real World Engine of a maze chase hybrid game system in accordance with some other embodiments of the invention.

FIG. 4 illustrates a signaling diagram of communications between a Real World Engine (RWE) and an external system to provide various functions in accordance with some embodiments of the invention.

FIG. 5 illustrates a conceptual diagram of a process flow and signaling in an RWE to provide various functions in accordance with some embodiments of the invention.

FIG. 6 illustrates a conceptual diagram of embodiments of an Entertainment System Engine (ESE) in accordance with some embodiments of the invention.

FIG. 7 illustrates a conceptual diagram of interactions between a user and a maze chase hybrid game system in accordance with some embodiments of the invention.

FIG. 8 illustrates conceptual diagram that illustrates the interplay between embodiments of a maze chase hybrid game system in accordance with some embodiments of the invention using Real World Currency (RC or RC).

FIG. 9 illustrates conceptual diagram that illustrates the interplay between embodiments of a maze chase hybrid game system in accordance with other embodiments of the invention using Virtual Real World Currency (VRC or VRC).

FIG. 10 illustrates a system diagram of an implementation of a network based maze chase hybrid game system in accordance with another embodiment of the invention.

FIG. 11 illustrates a system diagram of an implementation of an Internet based maze chase hybrid game system in accordance with an embodiment of the invention.

FIG. 12 illustrates a system diagram of an implementation of a cloud based maze chase hybrid game system in accordance with some embodiments of the invention.

FIG. 13 is process flow diagram of a process of a maze chase hybrid game system in accordance with embodiments of the invention.

FIG. 14 is an illustration of a user interface of a maze chase hybrid game system in accordance with embodiments of the invention.

FIGS. 15A and 15B are illustrations of another user interface of a maze chase hybrid game system in accordance with embodiments of the invention.

FIGS. 16A and 16B are illustrations of another user interface of a maze chase hybrid game system in accordance with embodiments of the invention.

FIG. 17 is another process flow diagram of a process of a maze chase hybrid game system in accordance with embodiments of the invention.

FIG. 18 is an architecture diagram of a processing apparatus in accordance with embodiments of the present invention.

FIGS. 19A and 19B illustrate operations of prior art simple gaming devices and systems.

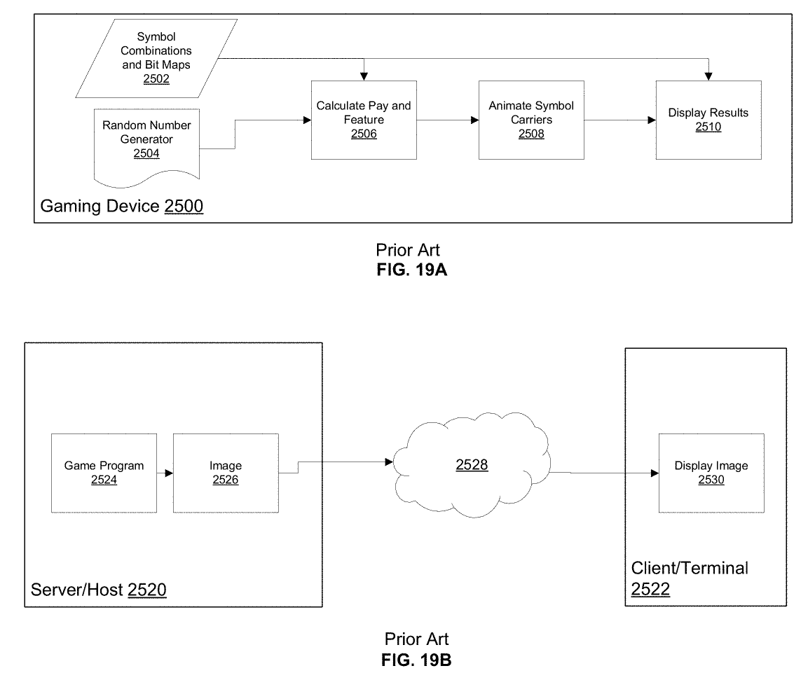

### DETAILED DESCRIPTION

Turning now to the drawings, systems and method for providing game world exchanges for maze chase hybrid game systems in accordance with some embodiments of the invention are illustrated. In accordance with some embodiments of the invention, system and methods collect game play metrics from a variety of types of maze chase hybrid game systems and determines effective exchange rates for game world credits, objects, experience points and the like for entertainment game portions of the various types of maze chase hybrid game systems.

### Hybrid Games

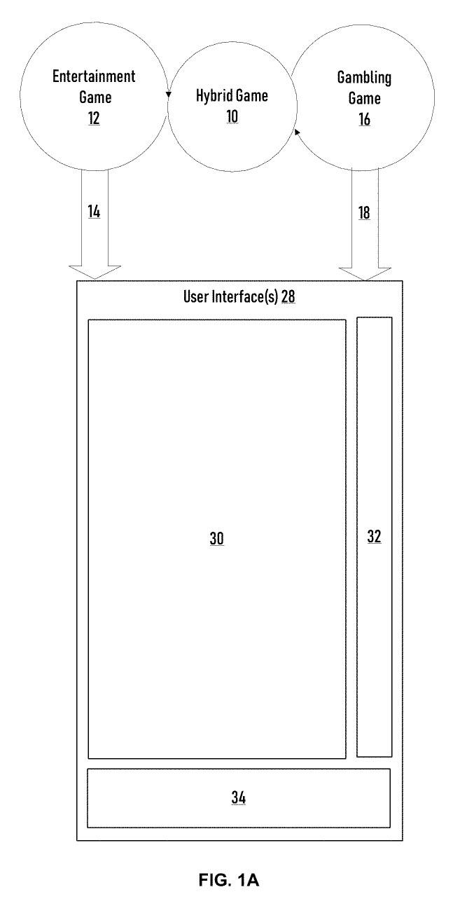

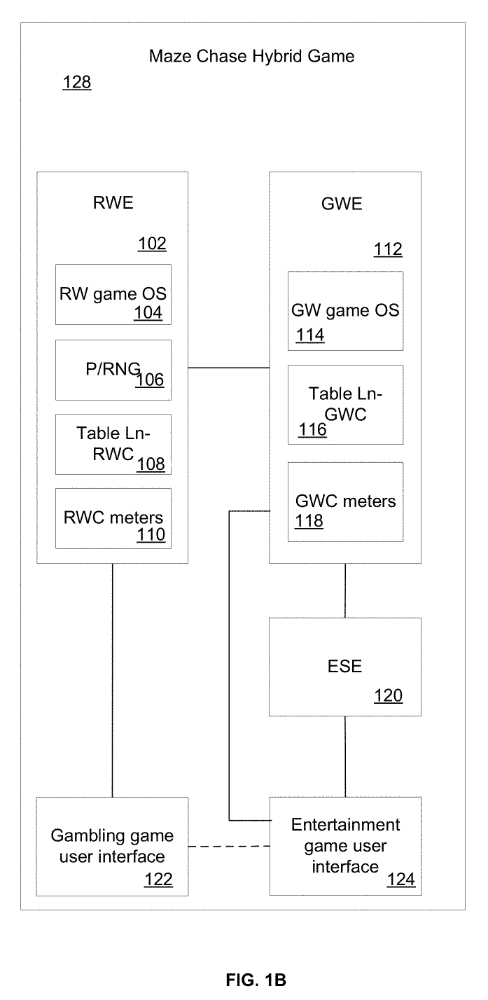

FIG. 1A is a block diagram illustrating an interactive user interface of a maze chase hybrid game system in accordance with various embodiments of the invention. A maze chase hybrid game system executes a hybrid game 10 having an entertainment game 12 and a gambling game 16. The entertainment game 12 communicates entertainment game data 14 to one or more interactive user interfaces 28 that are used to display to a player an interactive presentation generated based on the entertainment game data 14. The gambling game 16 communicates gambling game data 18 to the one or more interactive user interfaces 28 that are used to display to the player an interactive presentation generated based on the gambling game data 18. By utilizing the one or more interactive user interfaces 28, the maze chase hybrid game system can integrate entertainment game events and gambling game outcomes into an interactive user interface and communicate a state of a <type of> wagering process to the player all the while running seamlessly from the player's perspective.

The one or more interactive user interfaces 28 include one or more entertainment game interactive user interface portions 30 having a display used to display to a player interactive objects that the player interacts with during gameplay of the entertainment game 12 of a <type of> wagering process. In many embodiments, the one or more interactive user interfaces 28 also include one or more gambling game interactive user interface portions 34 having a display used to display to a player a status of a gambling game of a <type of> wagering process. In many embodiments, the one or more interactive user interfaces 28 also include one or more wagering process interactive user interface portions 32 having a display used to display to a player a gambling game outcome determination process.

In some embodiments, the maze chase hybrid game system's interactive user interfaces and associated displays allow transparent coupling of an entertainment game to wagering propositions, providing a seamless perspective to the player that they are playing an entertainment game. In accordance with some embodiments, a maze chase hybrid game system can be used to enable a wide range of interactive video games including but not limited to popular titles from arcade and home video games, such as but not limited to, Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.).

In accordance with many embodiments of the invention, a maze chase hybrid game system integrates high-levels of entertainment content with a game of skill (entertainment game) and a gambling experience with a game of chance (gambling game). A maze chase hybrid game system provides for random outcomes independent of player skill while providing that the user's gaming experience (as measured by obstacles/challenges encountered, time of play and other factors) is shaped by the player's skill. The outcome of a gambling proposition that is determined by a Pseudo/Random Number Generator (P/P/RNG) or other such device that provides a pseudo random or random outcome in response to a gambling request. In accordance with some embodiments, the wager game may be initiated in response to a game object related player action.

A maze chase hybrid game system in accordance with an embodiment of the invention is illustrated in FIG. 1. The maze chase hybrid game system 128 includes a Real World Engine (RWE) 102, a Game World Engine (GWE) 112, an Entertainment System Engine (ESE) 120, a gambling game user interface 122 and an entertainment game user interface 124. The two user interfaces can be part of the same user interface but are separate in the illustrated embodiment. The RWE 102 is connected with the GWE 112 and the gambling game user interface 122. The ESE 120 is connected with the GWE 112 and the entertainment game user interface 124. The GWE 112 is connected also with the entertainment game user interface 124.

In accordance with several embodiments, the RWE 102 is the operating system for the gambling game of the maze chase hybrid game system 128 and controls and operates the gambling game. The operation of a gambling game is enabled by Real World Currency (RC), such as money or other real world funds. A gambling game can increase or decrease an amount of RC based on random gambling outcomes, where the gambling proposition of a gambling game is typically regulated by gaming control bodies. In many embodiments, the RWE includes a Real World (RW) operating system (OS) 104, P/RNG 106, level n real-world credit pay tables (table Ln-RC) 108, RC meters 110 and other software constructs that enable a game of chance to offer a fair and transparent gambling proposition, and to contain the auditable systems and functions that can enable the game to obtain gaming regulatory body approval.

A random number generator (P/RNG) 106 includes software and/or hardware algorithms and/or processes, which are used to generate random outcomes. A level n real-world credit pay table (table Ln-RC) 108 is a table that can be used in conjunction with a random number generator (P/RNG) 106 to dictate the RC earned as a function of sponsored gameplay and is analogous to the pay tables used in a conventional slot machine. Table Ln-RC payouts are independent of player skill. There can be one table or multiple tables included in Ln-RC pay tables 108 contained in a gambling game, the selection of which can be determined by factors including (but not limited to) game progress that a player has earned, and/or bonus rounds for which a player can be eligible. RCs are credits analogous to slot machine game credits, which are entered into a gambling game by the user, either in the form of money such as hard currency or electronic funds. RCs can be decremented or augmented based on the outcome of a random number generator according to the table Ln-RC real world credits pay table 108, independent of player skill. In certain embodiments, an amount of RC can be used as criteria in order to enter higher ESE game levels. RC can be carried forward to higher game levels or paid out if a cash out is opted for by a player. The amount of RC used to enter a specific level of the game level n need not be the same for each level.

In accordance with some embodiments of the invention, the GWE 112 manages the overall maze chase hybrid game system operation, with the RWE 102 and the ESE 120 effectively being support units to the GWE 112. In accordance with some of these embodiments, the GWE 112 contains mechanical, electronic, and software systems for an entertainment game. The GWE 112 includes an operating system (OS) 114 that provides control of the entertainment game. The GWE additionally contains a level n game world credit pay table (table Ln-GWC) 116 from where to take input from this table to affect the play of the entertainment game. The GWE 112 can further couple to the RWE 102 to determine the amount of RC available on the game and other metrics of wagering on the gambling game (and potentially affect the amount of RC in play on the RWE). The GWE additionally contains various audit logs and activity meters (such as the GWC meter) 118. The GWE 112 can also couple to a centralized server for exchanging various data related to the player and their activities on the game. The GWE 112 furthermore couples to the ESE 120.

In accordance with some embodiments, a level n game world credit pay table (Table Ln-GWC) 116 dictates the Game World Credit (GWC) earned as a function of player skill in the nth level of the game. The payouts governed by this table are dependent upon player skill and sponsored gameplay at large and can or cannot be coupled to a P/RNG. In accordance with some embodiments, GWCs are player points earned or depleted as a function of player skill, specifically as a function of player performance in the context of the game. GWC is analogous to the score in a typical video game. Each entertainment game has one or more scoring criterion, embedded within the table Ln-GWC 116 that reflects player performance against the goal(s) of the game. GWCs can be carried forward from one level of sponsored gameplay to another, and ultimately paid out in various manners such as directly in cash, or indirectly such as by earning entrance into a sweepstakes drawing, or earning participation in, or victory in, a tournament with prizes. GWCs can be stored on a player tracking card or in a network-based player tracking system, where the GWCs are attributed to a specific player.

In accordance with certain embodiments, the operation of the GWE does not affect the RWE's gambling operation except for player choice parameters that are allowable in slot machines, including but not limited to, wager terms such as, but not limited to, a wager amount, how fast the player wants to play (by pressing a button or pulling the handle of a slot machine), and/or agreement to wager into a bonus round. In this sense, the RWE 102 provides a fair and transparent, non-skill based gambling proposition co-processor to the GWE 112. In the illustrated embodiment, the communication link shown between the GWE 112 and the RWE 102 allows the GWE 112 to obtain information from the RWE 102 as to the amount of RC available in the gambling game. The communication link can also convey a status operation of the RWE (such as on-line or tilt). The communication link can further communicate the various gambling control factors which the RWE 102 uses as input, such as the number of RC consumed per game or the player's election to enter a jackpot round. In FIG. 1, the GWE 112 is also shown as connecting to the player's user interface directly, as this can be utilized to communicate certain entertainment game club points, player status, control the selection of choices and messages which a player can find useful in order to adjust the entertainment game experience or understand their gambling status in the RWE 102.

In accordance with various embodiments of the invention, the ESE 120 manages and controls the visual, audio, and player control for the entertainment game. In accordance with certain embodiments, the ESE 120 accepts input from a player through a set of hand controls, and/or head, gesture, and/or eye tracking systems and outputs video, audio and/or other sensory output to a user interface. In accordance with many embodiments, the ESE 120 can exchange data with and accept control information from the GWE 112. In accordance with some of these embodiments, an ESE 120 can be implemented using a personal computer (PC), a Sony PlayStation® (a video game console developed by Sony Computer Entertainment of Tokyo Japan), or Microsoft Xbox® (a video game console developed by Microsoft Corporation of Redmond, Wash.) running a specific entertainment game software program. In accordance with some of these embodiments, ESE 120 can be an electromechanical game system of a draw certificate based maze chase hybrid game system that is an electromechanical maze chase hybrid game system. An electromechanical maze chase hybrid game system executes an electromechanical game for player entertainment. The electromechanical game can be any game that utilizes both mechanical and electrical components, where the game operates as a combination of mechanical motions performed by at least one player or the electromechanical game itself. Various electromechanical maze chase hybrid game systems are discussed in Patent Cooperation Treaty Application No. PCT/US12/58156, filed Sep. 29, 2012, the contents of which are hereby incorporated by reference in their entirety.

The ESE 120 operates mostly independently from the GWE 112, except that via the interface, the GWE 112 can send certain entertainment game control parameters and elements to the ESE 120 to affect its play, such as (but not limited to) what level of character to be using, changing the difficulty level of the game, changing the type of gun or car in use, and/or requesting potions to become available or to be found by the character. These game control parameters and elements can be based on a gambling outcome of a gambling game that was triggered by an element in the entertainment game being acted upon by the player. The ESE 120 can accept this input from the GWE 112, make adjustments, and continue entertainment game gameplay all the while running seamlessly from the player's perspective. The ESE's operation is mostly skill based, except for where the ESE's processes can inject complexities into the game by chance in its normal operation to create unpredictability in the entertainment game. Utilizing this interface, the ESE 120 can also communicate player choices made in the game to the GWE 112, such as but not limited to selection of a different gun, and/or the player picking up a special potion in the GW environment. The GWE's function in this architecture, being interfaced with the ESE 120, is to allow the transparent coupling of entertainment software to a fair and transparent random chance gambling game, providing a seamless perspective to the player that they are playing a typical popular entertainment game (which is skill based). In accordance with certain embodiments, the ESE 120 can be used to enable a wide range of entertainment games including but not limited to popular titles from arcade and home video games, such as but not limited to Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.). Providers of such software can provide the previously described interface by which the GWE 120 can request amendments to the operation of the ESE software in order to provide seamless and sensible operation as both a gambling game and an entertainment game.

In accordance with some embodiments, the RWE 102 can accept a trigger to run a gambling game in response to actions taken by the player in the entertainment game as conveyed by the ESE 120 to the GWE 112, or as triggered by the GWE 112 based on its algorithms, background to the overall game from the player's perspective, but can provide information to the GWE 112 to expose the player to certain embodiments of the gambling game, such as (but not limited to) odds, amount of RC in play, and amount of RC available. The RWE 102 can accept modifications in the amount of RC wagered on each individual gambling try, or the number of gambling games per minute the RWE 102 can execute, entrance into a bonus round, and other factors, all the while these factors can take a different form than that of a typical slot machine. An example of a varying wager amount that the player can choose can include, but is not limited to, gameplay with a more powerful character, a more powerful gun, or a better car. These choices can increase or decrease the amount wagered per individual gambling game, in the same manner that a standard slot machine player can decide to wager more or less credits for each pull of the handle. In accordance with some of these embodiments, the RWE 102 can communicate a number of factors back and forth to the GWE 112, via an interface, such increase/decrease in wager being a function of the player's decision making as to their operational profile in the entertainment game (such as but not limited to the power of the character, gun selection or car choice). In this manner, the player is always in control of the per game wager amount, with the choice mapping to some parameter or component that is applicable to the entertainment game experience of the maze chase hybrid game system. In accordance with a particular embodiment, the RWE 102 operation can be a game of chance as a gambling game running every 10 seconds where the amount wagered is communicated from the GWE 112 as a function of choices the player makes in the operation profile in the entertainment game.

In many embodiments, a maze chase hybrid game system integrates a video game style gambling machine, where the gambling game (including an RWE 102 and RC) is not player skill based, while at the same time allows players to use their skills to earn club points which a casino operator can translate to rewards, tournament opportunities and prizes for the players. The actual exchange of monetary funds earned or lost directly from gambling against a game of chance in a gambling game, such as a slot machine, is preserved. At the same time, a rich environment of rewards to stimulate gamers can be established with the entertainment game. In accordance with some of these embodiments, the maze chase hybrid game system can leverage very popular titles with gamers and provides a sea change environment for casinos to attract players with games that are more akin to the type of entertainment that a younger generation desires. In accordance with various embodiments, players can use their skill towards building and banking GWC that in turn can be used to win tournaments and various prizes as a function of their gamer prowess. Numerous embodiments minimize the underlying changes needed to the aforementioned entertainment software for the maze chase hybrid game system to operate within an entertainment game construct, thus making a plethora of complex game titles and environments, rapid and inexpensive to deploy in a gambling environment.

In accordance with some embodiments, maze chase hybrid game systems also allow players to gain entry into subsequent competitions through the accumulation of game world credits (GWC) as a function of the user's demonstrated skill at the game. These competitions can pit individual players or groups of players against one another and/or against the casino to win prizes based upon a combination of chance and skill. These competitions can be either asynchronous events, whereby players participate at a time and/or place of their choosing, or they can be synchronized events, whereby players participate at a specific time and/or venue.

In accordance with some embodiments, one or more players engage in playing an entertainment game, resident in the ESE, the outcomes of which are dependent at least in part on skill. The maze chase hybrid game system can include an entertainment game that includes head to head play between a single player and the computer, between two or more players against one another, or multiple players playing against the computer and/or each other, as well as the process by which players bet on the outcome of the entertainment game. The entertainment game can also be a game where the player is not playing against the computer or any other player, such as in games where the player is effectively playing against himself or herself (such as but not limited to Solitaire and Babette).

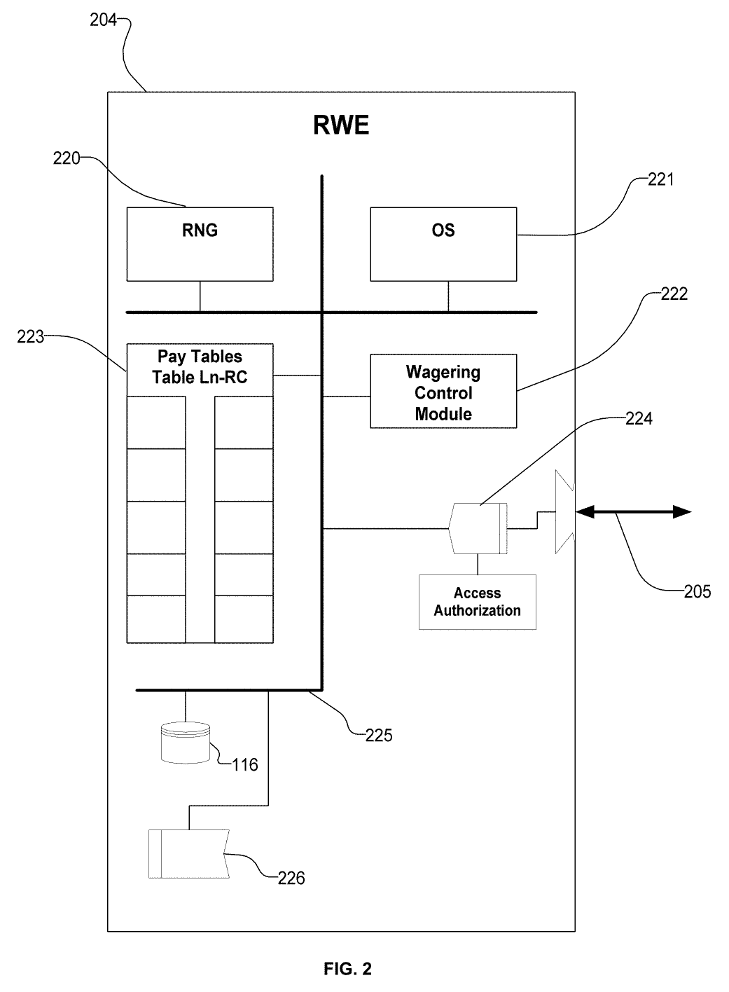

The components provided by the RWE for a maze chase hybrid game system in accordance with some embodiments of the invention are shown in FIG. 2. In accordance with some embodiments of the invention, the RWE includes an internal bus 225 that connects an operating system OS 221, a Random Number Generator (“P/RNG”) 220, one or more pay tables (Table Ln-RC) 223 which would control the functions of the RWE, a Random Number Generator (“P/RNG”) 220 to produce random numbers, one or more pay tables (Table Ln-RC) 223, a wagering control module 222, an authorization access module 224, and a RC credit meter 226 that are included in the RWE 204. The RW OS 221 controls the functions of the RWE. The P/RNG 220 includes one or more P/RNGs that are used to produce random numbers for use in resolving gambling events and other process requiring a random number to determine an outcome. The one or more pay tables (Table Ln-RC) 223 contain a plurality of factors indexed by the random number to be multiplied with the RC wagered to determine the payout on a successful wager. A wagering control module 222 performs the processes to resolve a wager on a proposition of a gambling event. The resolution process includes, but is not limited to, pulling random numbers, looking up factors in Pay Tables, multiplying the factors by the amount of RC wagered, and administering a RC credit meter 226. A repository (a credit meter) 926 maintains a record of the amount of RC which player has deposited in the game and has been accumulated by the player.

An external connection allows the RWE 204 to interface to another system or device, which is shown in FIG. 2 as the internet 205 but may be any other network and/or device. The authorization access module 224 of RWE 204 is connected to the external connection and provides a method to permit access and command exchange between an external system and the RWE 904. The RWE 904 also contains storage for statuses, wagers, wager outcomes, meters and other historical events in a storage device 116.

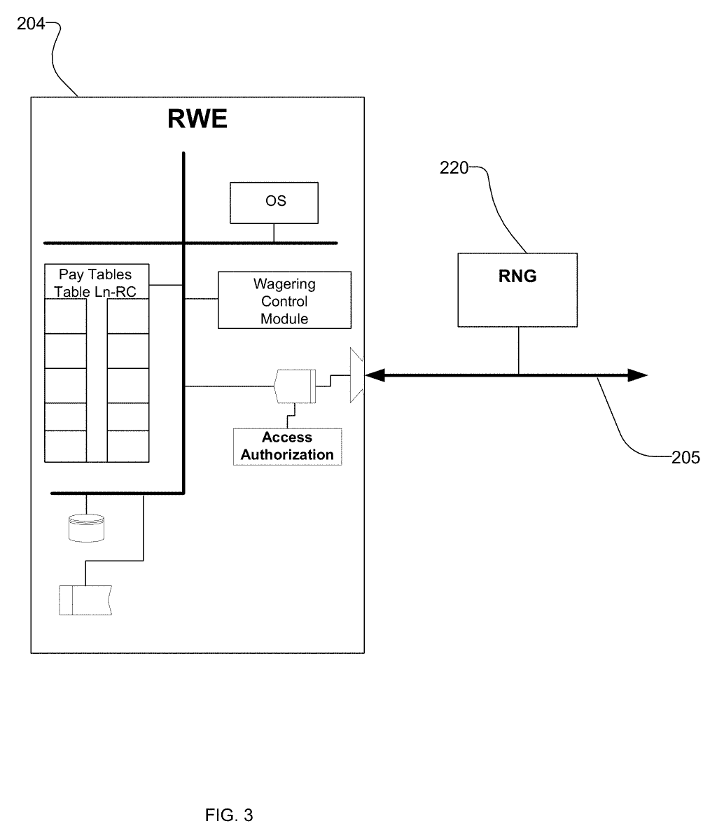

In some embodiments, the RWE communicates with external systems to provide various functions of a maze chase hybrid game system in accordance with some embodiments of the invention. The components of an RWE that communicate with an external system to provide a component of the RWE in accordance with some embodiments of the invention are shown in FIG. 3. The RWE 204 shown in FIG. 3 is similar to the RWE shown in FIG. 2. However, the P/RNG 220 which is an external system connected to the RWE 204 by the internet 905 in accordance with some embodiments of the invention. The P/RNG 220 could be a central deterministic system, such as a regulated and controlled random numbered ball selection device, or some other system which provides random or pseudo random numbers to one or a plurality of connected RWEs 204. One skilled in the art will recognize that only P/RNG 220 is an external system in the shown embodiments. However, any of the components could be external systems without departing from the spirit of this invention and P/RNG 220 is shown as an example only.

In FIGS. 2 and 3, the RWE 204 interfaces with other systems/devices or to an external P/RNG 220 using the Internet 205. However, one skilled in the art will note that nothing would preclude using a different interface than the internet 205 in other embodiments of the invention. Other examples of interfaces include, but are not limited to, a LAN, a USB interface, or some other method by which two electronic and software constructs could communicate with each other.

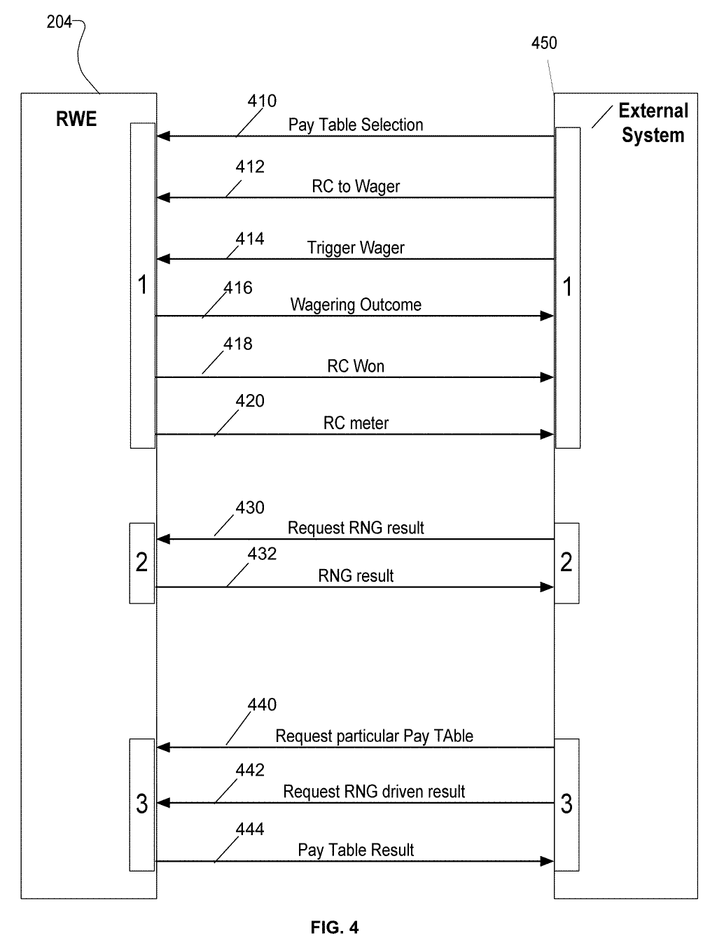

The RWE and an external system typically communicate to provide the resolution of gambling events to resolve wagers on the events. The signals between the RWE and an external system to provide some process related to resolving gambling events in accordance with some embodiments of the invention are shown in FIG. 4. In accordance with some embodiments of the invention, the primary function of the RWE 204 is to manage wagering events and to provide random (or pseudo random) numbers from an P/RNG. At the top of the figure, a 6 component communication exchange grouped by the “1” box is shown for a wager on a proposition in a gambling event during a maze chase hybrid game system in accordance with some embodiments of the invention. An external system 450 that is requesting wagering support from the RWE 204 instructs the RWE 204 as to the pay table (Table Ln-RC) to use (410), followed by the amount of RC to wager on the proposition of the gambling event (412). Next, the external system 450 signals the RWE to trigger a wager or perform the gambling event (414). The RWE 204 resolves the gambling event. The RWE 204 then informs external system 450 as to the outcome of the wager (416), the amount of RC won (418), and the amount of RC in the player's account (in the credit repository) (420).

A second communication exchange between the RWE 204 and an external system 450 in accordance with some embodiments of the invention that is shown in FIG. 4 is grouped by the “2” box in FIG. 4 and relates to the external system 450 needing an P/RNG result support from the RWE 204. In this exchange, the external system 450 requests an P/RNG result from the RWE 204 (430). The RWE 204 returns an P/RNG result to the external 450 in response to the request (432). The result may be generated as a function of the internal P/RNG in the RWE 204, or from an P/RNG external to the RWE 204 to which the RWE 204 is connected.

A third communication exchange between the RWE 204 and the external system 405 in accordance with some embodiments of the invention that is shown in FIG. 4 is grouped by the “3” box in the figure and relates to the external system 450 wanting support on coupling an P/RNG result to a particular Pay Table contained in the RWE 204. In this exchange, the external system 450 instructs the RWE as to the pay table (Table Ln-RC) to use 450. The external system then requests a result whereby the P/RNG result is coupled to the requested Pay Table (442). The result is returned to the external system 405 by RWE 204 (444). Such an embodiment is different from the first exchange shown by the box“1” sequence in that no actual RC wager is conducted. However, such a process t might be useful in coupling certain non-RC wagering entertainment game behaviors and propositions to the same final resultant wagering return which is understood for the maze chase hybrid game system to conduct wagering.

In regards to FIG. 4, one skilled in the art will note that the thrust of the FIG. 4 is to convey overall functional exchanges between an RWE 204 and an external system 450. As such, various protocol layers used for error free and secure communication, and other status, setup, and configuration commands which one might expect in any protocol between two connected systems have been omitted for clarity. Furthermore, some or all of the various commands and responses illustrated could be combined into one or more communication packets without departing from the spirit of this invention.

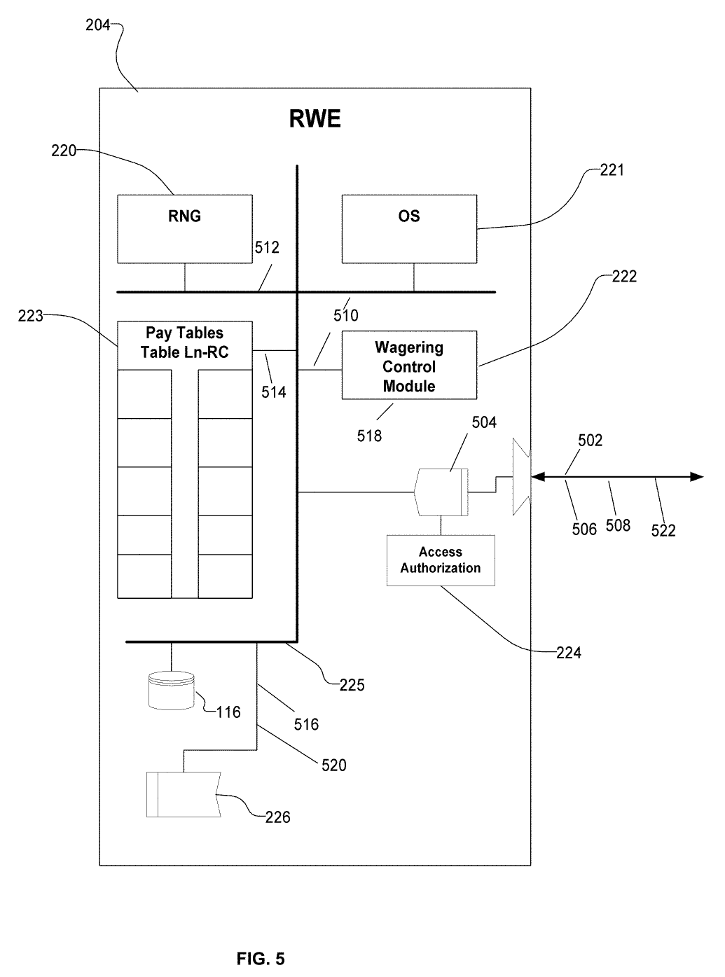

The process flow for functional communication exchanges, such as communication exchanges described above with reference to FIG. 4, between a RWE and an external system in accordance with some embodiments of the invention are shown in FIG. 5. The process begins by a RWE 204 receiving signals from an external system requesting a connection to RWE 204. The Access Authorization Module determines that the external system authorized to connect to RWE 204 (504) and transmits an authorization response to the external system. The external systems that provide requests a request for a gambling event is to be performed to RWE 294 (506). The request may include an indication of a wager amount on a proposition in the gambling event, and a proper pay table to use to resolve the wager. The external system then sends a signal to trigger the gambling event (508).

The OS 221 instructs the Wager Control Module 222 as to the RC wager and the Pay Table to select as well as to resolve the wager execute (510). In response to the request to execute the gambling event, the wager control module 222 requests an P/RNG result from the P/RNG 220 (512); retrieves a proper pay table or tables from the pay tables 223 (514); adjusts the RC of the player in the RC repository 926 as instructed (516; applies the P/RNG result to the particular pay table or tables (518); and multiplies the resultant factor from the Pay Table by the amount of RC to determine the result of the wager (518). Wager Control Module 222 then adds the amount of RC won by the wager to the RC repository 426 (520); and provides he outcome of the wager, and the amount of RC in the RWE and the RC won (522). One skilled in the art will recognize that there may be many embodiments of an RWE 204 which could be possible, including forms where many modules and components of the RWE are located in various servers and locations, so the foregoing is not meant to be exhaustive or all inclusive, but rather provide information about an RWE 204 in accordance with some embodiments of the invention.

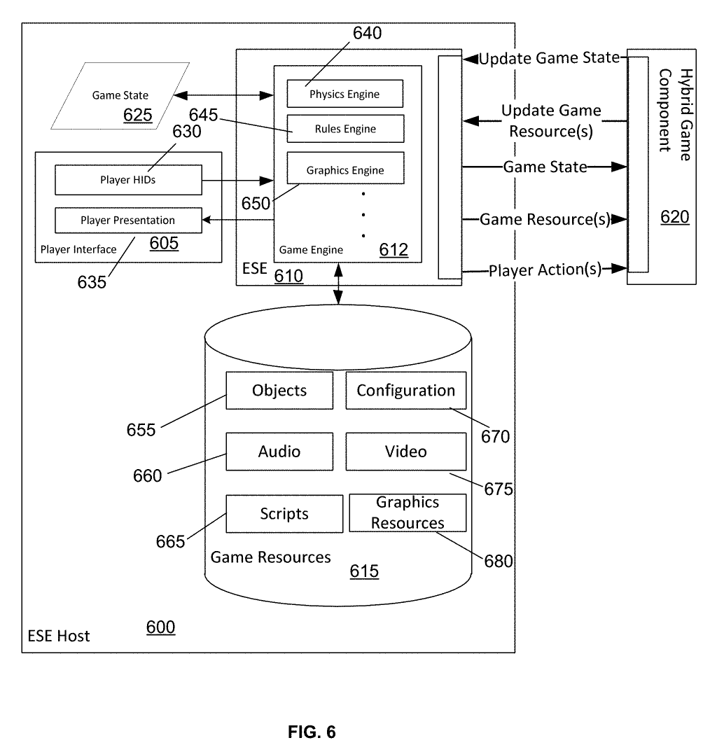

A block diagram of components an ESE being provided by an ESE host for a maze chase hybrid game system in accordance with some embodiments of the invention are shown in FIG. 6. An ESE 610 may be part of the entertainment game itself, may be a software module that is executed by the entertainment game, or may provide an execution environment for the entertainment game for a particular host. The ESE 610 and associated entertainment game are hosted by an ESE host 600. The ESE host 600 is a computing device that is capable of hosting the ESE 610 and the entertainment game. Exemplary hosts include video game consoles, smart phones, personal computers, tablet computers, or the like. The entertainment game includes a game engine 612 that generates a player interface 605 for interaction with by a player. The player interface includes a player presentation 635 that is presented to a player through the player interface. The player presentation 635 may be audio, visual or tactile, or any combination of such. The player interface 635 further includes one or more Human Input Devices (HIDs) 630 that the player uses to interact with the entertainment game. Various components or sub-engines of the game engine read data from a game state in order to implement the features of the game. Components of the game engine include a physics engine 640 used to simulate physical interactions between virtual objects in the game state, a rules engine 645 for implementing the rules of the game, an P/RNG that may be used for influencing or determining certain variables and/or outcomes to provide a randomizing influence on game play, a graphics engine 650 used to generate a visual representation of the game state to the player, an audio engine to generate audio outputs for the player interface, and any other engine needed to provide the entertainment game. The game engine 612 reads and writes game resources 615 stored on a data store of the ESE host. The game resources 615 include game objects 655 having graphics and/or control logic used to implement game world objects of the game engine. The game resources 615 also include video files 675 that are used to generate cut-scenes for the entertainment game. The game resources 615 may also include audio files 660 used to generate music, sound effects, etc. within the entertainment game. The game resources 615 may also include configuration files 670 used to configure the features of the entertainment game. The game resources 615 may also include scripts 665 or other types of control code used to implement various game play features of the entertainment game. The game resources 615 may also include graphics resources 680 including, but not limited to, textures, and objects that are used by the game engine to render objects displayed in the entertainment game.

In operation, components of the game engine 612 read portions of the game state 625 and generate the player presentation for the player which is presented to the player using the player interface 605. The player perceives the presentation 635 and provides player inputs using the HIDs 630. The corresponding player inputs are received as player actions or inputs by various components of the game engine 612. The game engine translates the player actions into interactions with the virtual objects of the game world stored in the game state 625. Components of the game engine 612 use the player interactions with the virtual objects of the game and the game state 625 to update the game state 625 and update the presentation 635 presented to the user. The process loops in a game loop continuously while the player plays the game.

The ESE 610 provides one or more interfaces between an entertainment game and other components 620 of a maze chase hybrid game system, such as a GWE. The ESE 610 and the other maze chase hybrid game system component 620 communicate with each other using the interfaces, such as by passing various types of data and sending and receiving messages, status information, commands and the like. Examples of communications include, but are not limited to, requesting by the maze chase hybrid game system component 620 that the ESE 610 update the game state using information provided by the other component; requesting, by the maze chase hybrid game system component 620, that the ESE 610 update one or more game resources using information provided by the maze chase hybrid game system component 620; the ESE 610 providing all or a portion of the game state; the ESE 610 providing one or more of the game resources to the maze chase hybrid game system component 620; and the ESE 610 communicating player actions to the other maze chase hybrid game system component 620. The player actions may be low level player interactions with the player interface, such as manipulation of an HID, or may be high level interactions with objects as determined by the entertainment game. The player actions may also include resultant actions such as modifications to the game state or game resources resulting from the player's actions taken in the game. Other examples of player actions include actions taken by entities, such as Non-Player Characters (NPC) of the entertainment game, that act on behalf of, or under the control of, the player.

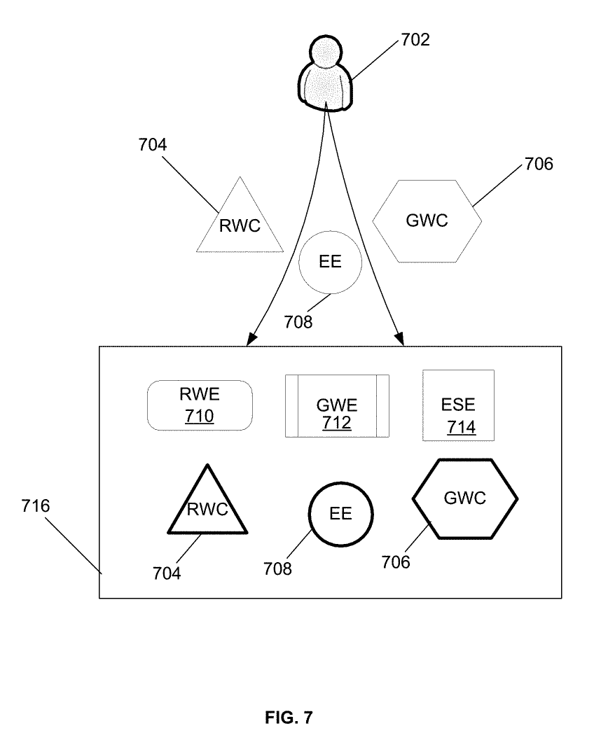

In accordance with some embodiments, a player can interact with a maze chase hybrid game system by using RC in interactions with a gambling game along with GWC and elements in interactions with an entertainment game. The gambling game can be executed by a RWE while an entertainment game can be executed with an ESE and managed with a GWE. A conceptual diagram that illustrates how resources such as GWC, RC and elements, such as but not limited to Entertainment Elements (EE), are utilized in a maze chase hybrid game system in accordance with an embodiment of the invention is illustrated in FIG. 7. The conceptual diagram illustrates that RC 704, EE 708 and GWC 706 can be utilized by a player 702 in interactions with the RWE 710, GWE 712 and ESE 714 of a based maze chase hybrid game system 716. The contribution of elements, such as EE 708, can be linked to a player's access to credits, such as RC 704 or GWC 706. Electronic receipt of these credits can come via a smart card, voucher or other portable media, or as received over a network from a server. In accordance with certain embodiments, these credits can be drawn on demand from a player profile located in a database locally on a maze chase hybrid game system or in a remote server.

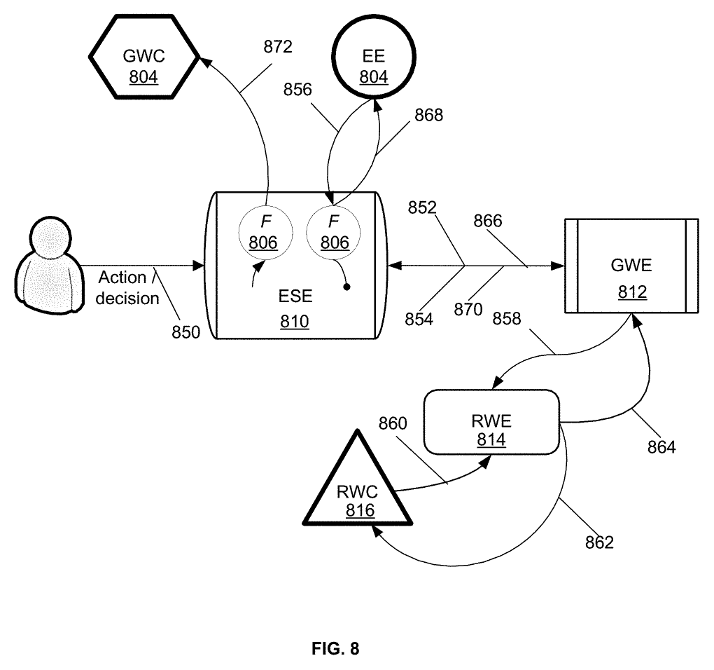

A conceptual diagram that illustrates the interplay between embodiments of a maze chase hybrid game system in accordance with an embodiment of the invention using Real World Currency (RC) is illustrated in FIG. 8. Similar to FIG. 7, a player's actions and/or decisions can affect functions 806 that consume and/or accumulate GWC 802 and/or EE 804 in an entertainment game executed by an ESE 810. A GWE 812 can monitor the activities taking place within an entertainment game executed by an ESE 810 for gameplay gambling event occurrences. The GWE 812 can also communicate the gameplay gambling event occurrences to an RWE 814 that triggers a wager of RC 816 in a gambling game executed by the RWE 814.

In accordance with some embodiments of the invention, the following may occur during use of the maze chase hybrid game system. The user enters an input that represents an action or decision (850). The ESE 810 signals the GWE 812 with the input decision or action (852). The GWE 812 responds by signaling to ESE 810 with the amount of EE that is consumed by the player action or decision (854). The signaling from the GWE 812 configures a function 806 to control the EE consumption, decay, and/or accumulation.

The ESE 810 then adjusts the EE 804 accordingly (856). The GWE 812 signals the RWE 814 as to the profile of the wager proposition associated with the action or decision and triggers the wager (858). The RWE 814 consumes the appropriate amount of RC 816 and executes the wager (860). The RWE 814 then adjusts the RC 816 based upon the outcome of the wager (862) and informs the GWE 812 as to the outcome of the wager (864).

The GWE 812 signals the ESE 810 to adjust EE to one or more of the EEs of the ESE entertainment game (866). Function 806 of the ESE 810 performs the adjustment of EE 804 (868). The ESE 810 signals the GWE 812 as to the updated status (870). In response, the GWE 812 signals the ESE 810 to update GWC of the entertainment game. The ESE updates the GWC 802 using a function 806 (872).

The following is an example of the above flow in a first person shooter game, such a Call of Duty®, using a maze chase hybrid game system sequence in accordance with some embodiments of the invention.

The process begins by a player selecting a machine gun to use in the game and then fires a burst of bullets at an opponent (850). The ESE 810 signals the GWE 812 of the player's choice of weapon, that a burst of bullets was fired, and the outcome of the burst (852). GWE 812 processes the information received and signals ESE 810 to consume 3 bullets (EE) with each pull of the trigger (854). The ESE 810 consumes 3 bullets for the burst using function 806 (856).

The GWE 812 signals the RWE 814 that 3 credits (RC) are to be wagered to match the three bullets consumed. The RWE 814 then determines the result of the wager and may determine the winnings from a pay table. On a particular pay table (Table Ln-RC), a determination is made by RWE 814 as to the amount of damage that the opponent has sustained. The RWE 814 consumes 3 credits of RC 816 for the wager and executes the specified wager (860). The RWE 814 determines that the player hit a jackpot of 6 credits and returns the 6 credits to the RC 816 (862) and signals the GWE 812 that 3 net credits were won by the player (864).

The GWE 812 signals ESE 810 to add 3 bullets to an ammunition clip (866). ESE 810 adds 3 bullets back to the ammo clip (EE 804) using a function 806 (868). The ammunition may be added by directly adding the ammunition to the clip or by allowing the user to find extra ammunition during game play. The GWE 812 logs the new player score (GWC 802) in the game (as a function of the successful hit on the opponent) based on the ESE 810 signaling, and the signals the ESE 810 to add 2 extra points to the player score since a jackpot has been won (870). The ESE 810 then adds 10 points to the player score (GWC 802) given the success of the hit which in this example is worth 8 points, plus the 2 extra points requested by GWE 812 (872). Note that the foregoing example is only intended to provide an illustration of how credits flow in a maze chase hybrid game system, but is not intended to be exhaustive and only lists only one of numerous possibilities of how a maze chase hybrid game system may be configured to manage its fundamental credits.

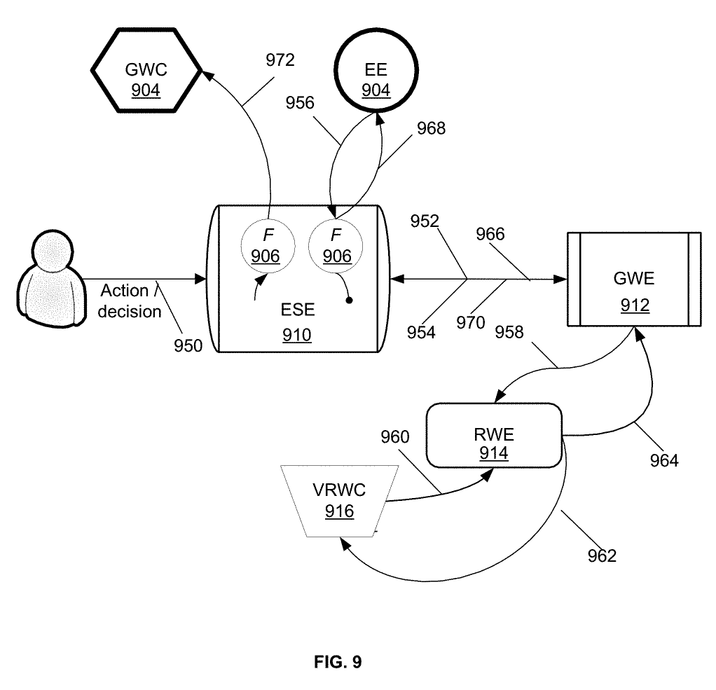

A conceptual diagram that illustrates the interplay between embodiments of a maze chase hybrid game system in accordance with an embodiment of the invention using Virtual Real World Currency (VRC) is illustrated in FIG. 9. As seen in the FIG. 9, substituting VRC in place of RC is effected without impact to the architecture or operation of the maze chase hybrid game system. The implementation of FIG. 9 is not the only embodiment using virtual currency within a maze chase hybrid game system, but shows only one permutation of which many could exist.

Similar to FIG. 8, a player's actions and/or decisions can affect functions 906 that consume and/or accumulate GWC 902 and/or EE 904 in an entertainment game executed by an ESE 910 in the process shown in FIG. 9. A GWE 912 can monitor the activities taking place within an entertainment game executed by an ESE 910 for gameplay gambling event occurrences. The GWE 912 can also communicate the gameplay gambling event occurrences to an RWE 914. Unlike the process shown in FIG. 8, RWE 914 triggers a wager of Virtual Real World Currency (VRC) 916 in a gambling game executed by the RWE 914.

For purposes of this discussion, VRC can be thought of as a form of alternate currency, which can be acquired, purchased or transferred, in unit or in bulk, by/to a player, but does not necessarily directly correlate to RC or real currency. As an example, there is a virtual currency called “Triax Jacks”, 1000 units of which are given to a player by an operator of a maze chase hybrid game system, with additional blocks of 1000 units being available for purchase for $5 USD each block. Triax Jacks could be redeemed for various prizes, or could never be redeemed but simply used and traded purely for entertainment value by players. It would be completely consistent with the architecture of the maze chase hybrid game system that Triax Jacks would be wagered in place of RC, such that the maze chase hybrid game system could be played for free, or with played with operator sponsored Triax Jacks.

Returning to the process in FIG. 9, the following may occur during use of the maze chase hybrid game system in accordance with some embodiments of the invention. The user enters an input that represents an action or decision (950). The ESE 910 signals the GWE 912 with the input decision or action (952). The GWE 912 responds by signaling to ESE 910 with the amount of EE that is consumed by the player action or decision (954). The signaling from the GWE 912 configures a function 906 to control the EE consumption, decay, and/or accumulation.

The ESE 910 then adjusts the EE 904 accordingly (956). The GWE 912 signals the RWE 914 as to the profile of the wager proposition associated with the action or decision and triggers the wager (958). The RWE 914 consumes the appropriate amount of RC 916 and executes the wager (960). The RWE 914 then adjusts the RC 916 based upon the outcome of the wager (962) and informs the GWE 912 as to the outcome of the wager (964).

The GWE 912 signals the ESE 910 to adjust EE to one or more of the EEs of the ESE entertainment game (966). Function 906 of the ESE 910 performs the adjustment of EE 904 (968). The ESE 910 signals the GWE 912 as to the updated status (970). In response, the GWE 912 signals the ESE 910 to update GWC 902 of the entertainment game. The ESE updates the GWC 902 using a function 906 (972).

### Network Based Hybrid Game

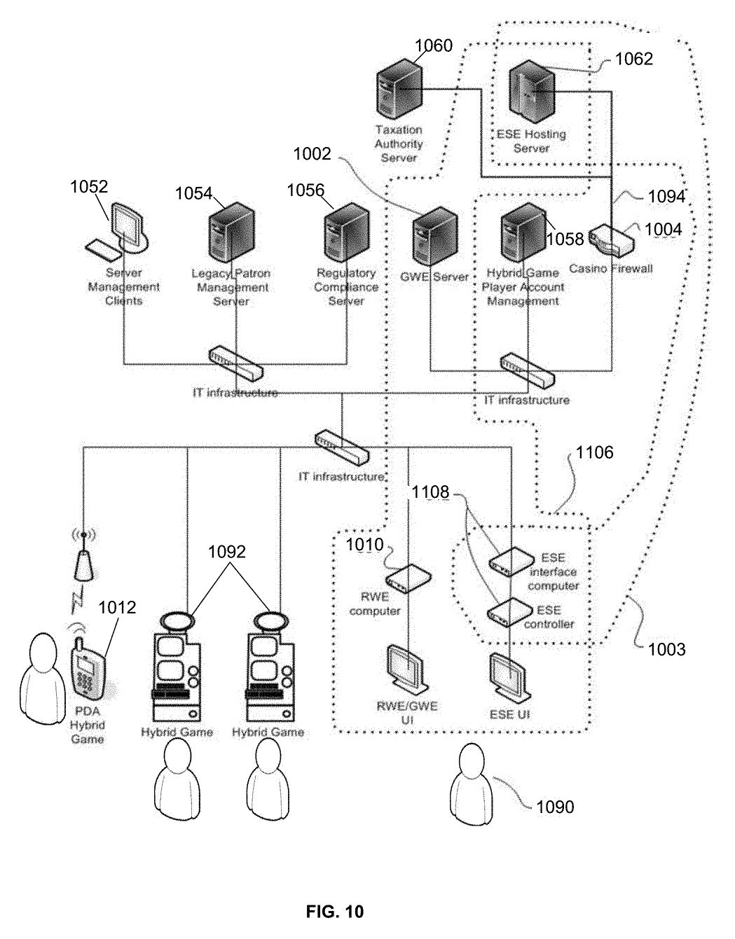

A system diagram that illustrates an implementation of a network distributed maze chase hybrid game system with a GWE local server in accordance with some embodiments of the invention is illustrated in FIG. 10. The system includes several maze chase hybrid game systems 806 sharing services from the same GWE local server 1002 over a network. The system includes several maze chase hybrid game systems 1006 sharing services from the same GWE local server 1002 over a network. Maze chase hybrid game system 1012 is a particular implementation where the maze chase hybrid game system is implemented on a mobile device connected to the network via a wireless connection. The remaining maze chase hybrid game systems 1019 are shown as stand-alone gaming consoles as may be used in a casino. However, a maze chase hybrid game system 1092 can be implemented on any device, including laptops, desktop computers, mobile phones, tablets or the like over a network connection. A single maze chase hybrid game system 1006 with a RWE 1010, ESE 1008 and GWE 1002 that is provided for user 1090 is enclosed within a dotted line. In accordance with some embodiments the ESE controller and interface in the system may interact with an ESE hosting server 1062, as denoted by dotted line 1003, to provide the ESE 1008. A number of other peripheral systems, such as, but not limited to, legacy patron management server 1052, client management server 1054, regulatory compliance server 1056, and maze chase hybrid game system player account management server 1058 can also interface with the game object maze chase hybrid game systems over a network within an operator's firewall 1004. Other servers can reside outside the bounds of a network within an operator's firewall 1004 to provide additional services for network connected game object maze chase hybrid game systems. Examples of such servers, include, but are not limited to taxation authority server 1060 and ESE hosting server 1062. One skilled in the art will recognize that although these systems are represented as one server that one or more connected servers or other processing systems may provide the same function without departing from this invention.

A system diagram that illustrates an implementation of a maze chase hybrid game system having a local and group GWE server in accordance with some embodiments of the invention is illustrated in FIG. 10. The system includes several maze chase hybrid game systems 906 sharing services from the same GWE local server 1191 over a network, such as internet 1105. Hybrid game 1114 is a particular implementation where the maze chase hybrid game system is implemented on a mobile device connected to the network via a wireless connection. The remaining maze chase hybrid game systems 1111 are shown as stand-alone gaming consoles as may be used in a casino. However, a gambling hybrid system 1111 can be implemented on any device, including laptops, desktop computers, mobile phones, tablets or the like over a network connection. A single maze chase hybrid game system 1106 with a RWE 1104, ESE 1112, and GWE 1102 is enclosed within a dotted line. This system includes a maze chase hybrid game system 1106 that includes a RWE 1104, an ESE 1112 and a GWE 1102. GWE 1102 shown enclosed within a dotted line but where a single maze chase hybrid game system can call upon services from servers within an operator's firewall 1107 (such as, but not limited to, a GWE local server 1191) as well as beyond an operator's firewall 1107 (such as, but not limited to, a GWE group server 1192). The GWE 1102 can coordinate multiple maze chase hybrid game systems from across a network that spans beyond an operator's firewall 1107. A GWE server system 1102 can include multiple GWE servers, such as, but not limited to, a GWE local server 1191 and a GWE group server 1192. Multiple network connected maze chase hybrid game systems 1106 can be connected to various servers to call upon services that enable the execution of the maze chase hybrid game system. These servers include but are not limited to client management server 1152 and legacy patron management server 1154 within the casino firewall 1107; and regulatory compliance server 1156, maze chase hybrid game system account management server 1158, taxation authority server 1160 and ESE hosting server 1162 outside the casino firewall 1107. One skilled in the art will recognize that servers may be single servers or a group of servers and processing systems providing the services without departing from this invention; and that the servers described may be within or outside of casino firewall 906 without departing from this invention.

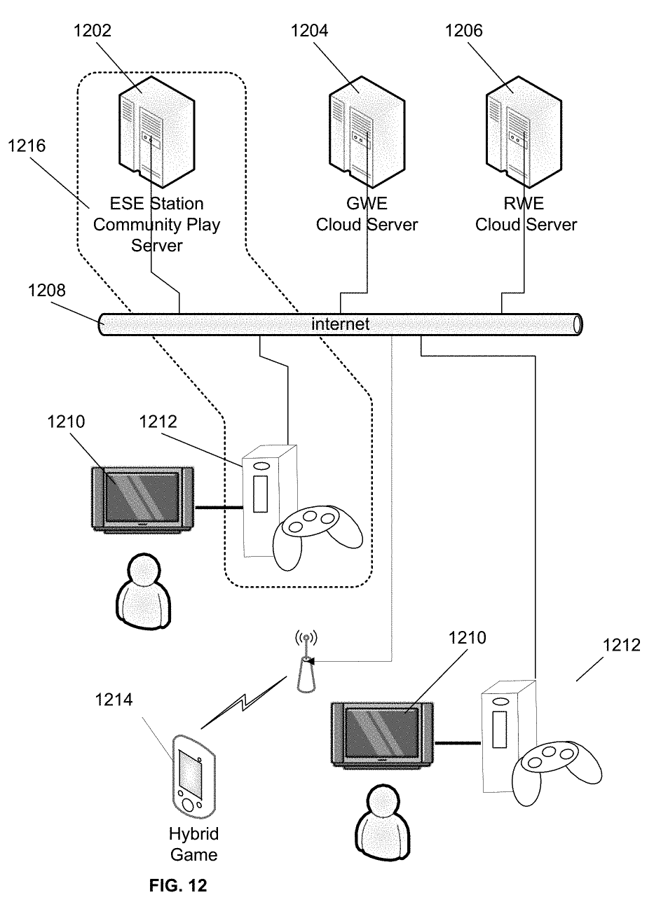

A system diagram that illustrates an implementation of network a cloud based maze chase hybrid game system over the Internet in accordance with an embodiment of the invention is illustrated in FIG. 12. The system includes an ESE server 1202, GWE server 1204 and RWE server 1206 that each connect to a user interface 1210 (such as, but not limited to, a television screen, computer terminal, tablet, touchscreen or PDA) of game object maze chase hybrid game systems over the Internet 1208. Each maze chase hybrid game system includes a local ESE 1212 (such as, but not limited to, a video game console or a gaming computer system) that interfaces with a remote ESE server 1002. Processes performed by an ESE 1212 services can be performed in multiple locations, such as, but not limited to, remotely on an ESE server 1202 and locally on a local ESE 1212. In addition, a maze chase hybrid game system may include a Personal Digital Assistant (PDA) 1214 or other type of mobile computing device game coupled to the ESE hosting server 1202, thus providing the opportunity for a player to play a maze chase hybrid game system on the PDA through a mobile phone or data network.

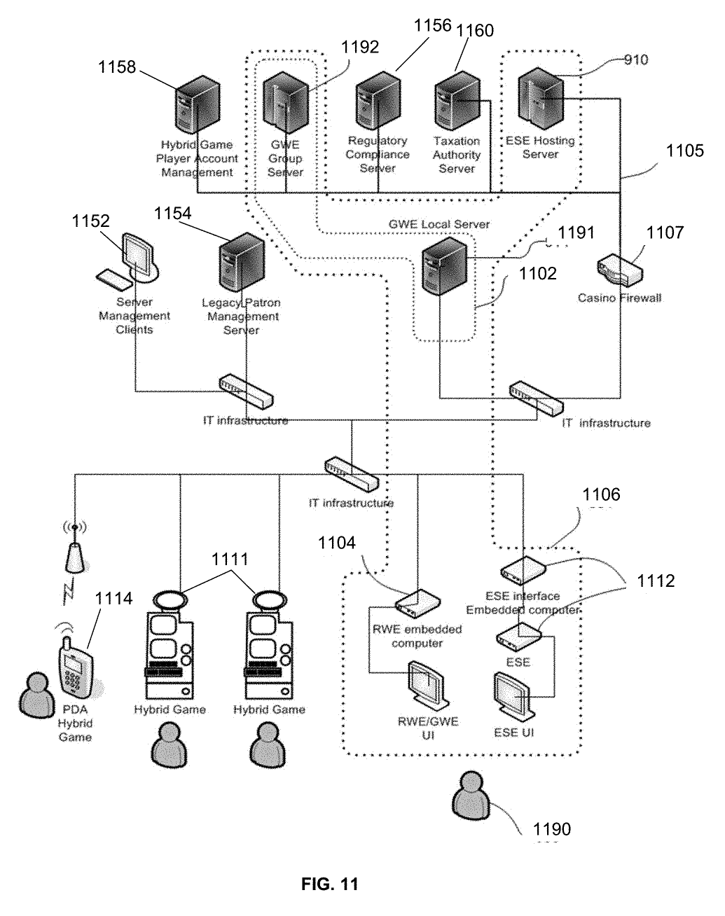

There are many possible permutations of the architecture of systems for providing a maze chase hybrid game system in accordance with some embodiments of the invention. FIGS. 10-12 show only three possible permutations and are provided as examples which are not intended to suggest limitations to the forms of the architecture. Other permutations might include a version where the entire maze chase hybrid game system is in the cloud with only a client running on player terminal within the bounds of the casino, or a permutation where the RWE and GWE are casino bound and the ESE exists in the cloud, accessed by a client running on a terminal in the casino.

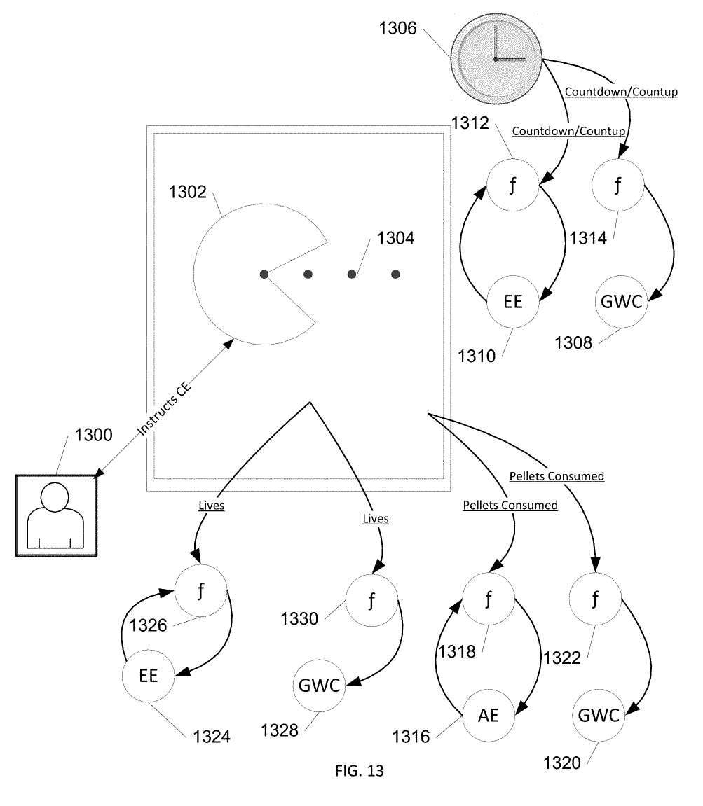

FIG. 13 illustrates a maze chase game as it is played as a maze chase hybrid game system. The maze chase hybrid game system may be deployed as an electronic game on a variety of hosts. For example, the maze chase hybrid game system may be deployed on a gaming cabinet as used in a traditional land-based casino. The maze chase hybrid game system may be deployed on a mobile computing device such as a Personal Digital Assistant (PDA), smartphone, tablet computer, laptop computer, etc. The maze chase hybrid game system may also be deployed on a game console, such as an XBox™, Playstation™, etc. The maze chase Hybrid game may also be deployed on a Personal Computer (PC). Each of the hosts may be operatively connected to other hosts via a network for the playing of head-to-head games. Furthermore, each of the hosts may also be further operatively connected to other types of systems and hosts as described herein.

Game Set Up

At the onset of game play, a player 1300 is given the choice of playing “solo” or in head-to-head mode. In solo mode the player, using a controlled entity 1302, seeks to consume pellets, such as pellet 1304 that line a maze in a minimum possible time (as symbolized by clock 1306), maximizing bonuses (by eating special pellets and consuming weakened enemies), and without touching dangerous enemies (ghosts). GWC 1308 is awarded as a function of the player's performance. In some embodiments, the player's performance is compared relative to a set of pre-established performance bands (e.g. less than 3 minutes, 3 min<x<5 min, 5 min<x<10 min, etc.) In some embodiments, a player's performance is considered as function of their performance against a historical database of completion times for players of approximately equivalent skill. In many embodiments, GWC can be further augmented or reduced as a function of game features such as, but not limited to, (a) the number of lives lost to enemies, (b) the number of enemies consumed, (c) the number of bonus pellets acquired during game play, etc.

In some embodiments, in head-to-head mode, the player is matched up against another player (or players), who may or may not be of proximate skill, and they play the same level. This may not be done in an exactly synchronous way (i.e. they may not have to start at the same time), though it can be. In head-to-head mode, more GWC is awarded to the player who finishes the level most quickly, again with the possibility of GWC awards and penalties as a function of various factors. Players may have the ability to directly engage with known persons to compete against, may choose opponents through an arbitrated process, or may be assigned opponents by the Hybrid Game system.

In many embodiments, to enable players of different skill levels to compete head-to-head, handicapping can be used. It can take one of a number of forms. In one example, the more advanced player starts with a time penalty, i.e. whereas the less skilled player's timer starts at 0:00:00 (hour:min:sec), the more skilled player's timer may start at 0:00:30 for a slight difference in skill, or at 0:1:30 for a greater skill disparity. This time penalty may be applied as a function of skill bands into which players fall (i.e. player A is in a low-skill band, and player B is in a high-skill band) or can be crafted in the context of the specific players themselves and their historical performance on levels of difficulty comparable to that currently being presented.

In some embodiments, another means of handicapping would alter the rate at which players accumulate GWC as a function of their in-game performance, the rate being higher for lower skilled players than higher skilled players. Another means would provide the lower skilled player with a fixed “bump” in GWC for the purposes of calculating the winner in the head-to-head competition.

In many embodiments, another means of handicapping would alter the speed at which enemies move as a function of their in-game performance, the speed being lower for lower skilled players than higher skilled players. Another means would provide the lower skilled player with a fixed “bump” in the number of lives available during gameplay.

In some embodiments, in addition to choosing whether to play solo or head-to-head, a player can make choices regarding the level to be played. A player may need to undertake a gambling game to initiate the selection of a different level (i.e. a different set of initial conditions) with the result of the gambling game affecting (for example) the difficulty of the level presented (said difficulty being explicitly communicated to the player or implicitly—for example by virtue of the size and complexity of the maze). A gambling proposition (the same as above, or a distinct one) can also affect the GWC “prize” available for a given, constant, level, the nature of the rules (i.e. what sort of things are penalized and/or rewarded), whether the game has a hard stop time-wise, and so on.

In some embodiments, the player can gamble repeatedly to configure the game to her liking, though the level may only be shown to the player for a short while before the player has to decide whether to go-forward with that level or select another (for example), to prevent gaming of the system.

In many embodiments, players also make selections about the amount of money to commit to each gambling

Game Play

Once the level has been established, and the rules set, play commences.

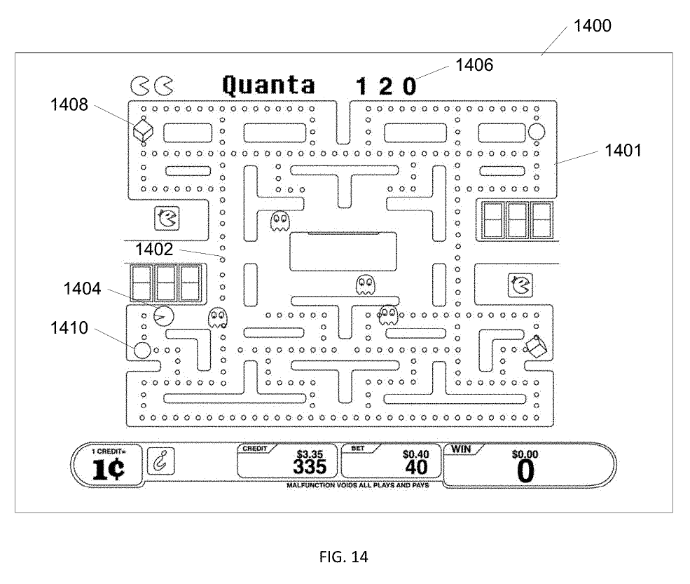

In one embodiment, the consumption of game time in a version of the game in which a clock counts down from X game-minutes towards zero serves as the enabling element (EE) 1310 that triggers or initiates (as indicated by function 1312) wagering in a gambling game. Gambling game wins augment the amount of game time available to complete the level. In another embodiment game time is counted up, and as each relevant unit of game time is consumed (EE), wagers or bets in a gambling game are initiated or triggered. This mechanism is further illustrated in FIG. 14. In addition, the time it takes for a player to accomplish goals in the game may be used to determine (as indicated by function 1314) an amount of GWC that the player earns for skillful play of the game.

In another embodiment, the number of pellets consumed (X) serve as actionable elements (AE) 1316 or enabling elements (EE), and are consumed by the player, initiating wagering or betting in the gambling game (as indicated by function 1318). In some embodiments, the amount gambled per consumption is established as part of the Game Set Up. In many embodiments, the number of pellets consumed is also used to determine (as indicated by function 1322) an amount of GWC 1320 awarded to the player during skillful play of the entertainment game portion of the maze chase hybrid game system.

In another embodiment, the number of “lives” 1316 of the controlled entity serve as EE 1324, and are consumed by the player, initiating or triggering betting or wagering in the gambling game (as indicated by function 1326). Gambling game wins ultimately augment the number of lives available. The amount gambled per life is established as part of the Game Set Up. In some embodiments, the number of lives awarded to the player are part of the GWC 1328 awarded to the player for skillful play of the entertainment game portion of the maze chase hybrid game system (as indicated by function 1330).

In some embodiments, a player has access to special ability. A player can use a special ability from an inventory of virtual “bonuses”. Special moves can be directly beneficial, “the controlled entity (CE) moves with 25% increased speed”, or they can be less direct, “the number of special pellets in the level has increased”. The bonuses can be pre-established and independent of the current state of the level, or they can be dependent upon the current state of game play. The use of a special ability (an EE) can invoke a gambling event, and the result of that gambling event can affect the quality of that ability provided, and/or a subsequent ability and/or augment (in the case of a gambling win, for example) the number of special abilities available to be drawn on a go-forward basis.

In many embodiments, GWC is awarded or decremented (i.e. it can start at a maximum value for the level at the onset and be reduced as a function of one or more game variables) as a function of one or more game variables, such as but not limited to: time to complete the level, number of enemies consumed, number of lives lost, performance against one or more of these elements relative to a competitor, competitors or a standard, etc. GWC levels can also be affected by the extent to which the player takes advantage of special abilities, etc.

In some embodiments, players can gain entrance to maze chase tournaments as a function of GWC accumulated or retained across one or more plays of the maze chase hybrid game system (in the case where GWC decrements from an optimal level over the course of game play) in the context of their skill level, casino preferences, and/or other variables. These tournaments can be skill-only or maze chase hybrid game system tournaments.

In some embodiments, players can work together as teams to complete maze chase levels. In this mode, players pool their funds and EE mechanisms are shifted to a cooperative enabling element (CEE) paradigm where players consume a shared pool of CEEs as EEs, and when a player earns more EE, the EE is added to the pool of CEE. The aforementioned ideas all apply in this context (i.e. teams can compete against one another, there can be different scoring and CEE mechanisms, etc., etc.). The players then may play alternating levels, until a life is lost, or other break in gameplay.

FIG. 14 is a screen display of a user interface for a player of a maze chase hybrid game system in accordance with an embodiment. The display 1400 includes a maze 1401 including dots, such as dot 1402, that a controlled entity 1404 consumes. In operation, as the controlled entity consumes the dots, GWC is awarded to the player for skillful play of the entertainment game portion of the maze chase hybrid game system, as indicated by GWC displayed value 1406. The maze also includes additional icons that are consumable by the controlled entity that initiate events that produce awards, such as but not limited to: a random event that results in an awarding of an in game object as an outcome; a random event having a wager of virtual credits or game world credits resulting in an award of an in game object as an outcome; or a gambling game having a wager of real credits and having as an outcome an award of real credits. For example, an icon 1408 that is consumed by the controlled entity initiates or triggers a wager using game world credit awarded to the player where a successful outcome includes awarding to the player a game world object. In contrast, when consumed by the controlled entity, another icon 1410 initiates a wager or bet in real credits in a gambling game.

In some embodiments, icons representing different types of random events to be triggered by consumption of the icons have different displayed physical representations or appearances. In one embodiment, an icon for initiating a random event leading to a possible award of an in-game object is depicted as a square or a cube and an icon initiating a random event was a wager of real credits in a gambling game portion of a maze chase hybrid game system is depicted as a sphere or circle. By use of different appearing icons, a player may make a determination of what type of event having a random outcome to initiate, and then control the controlled entity to consume that icon.

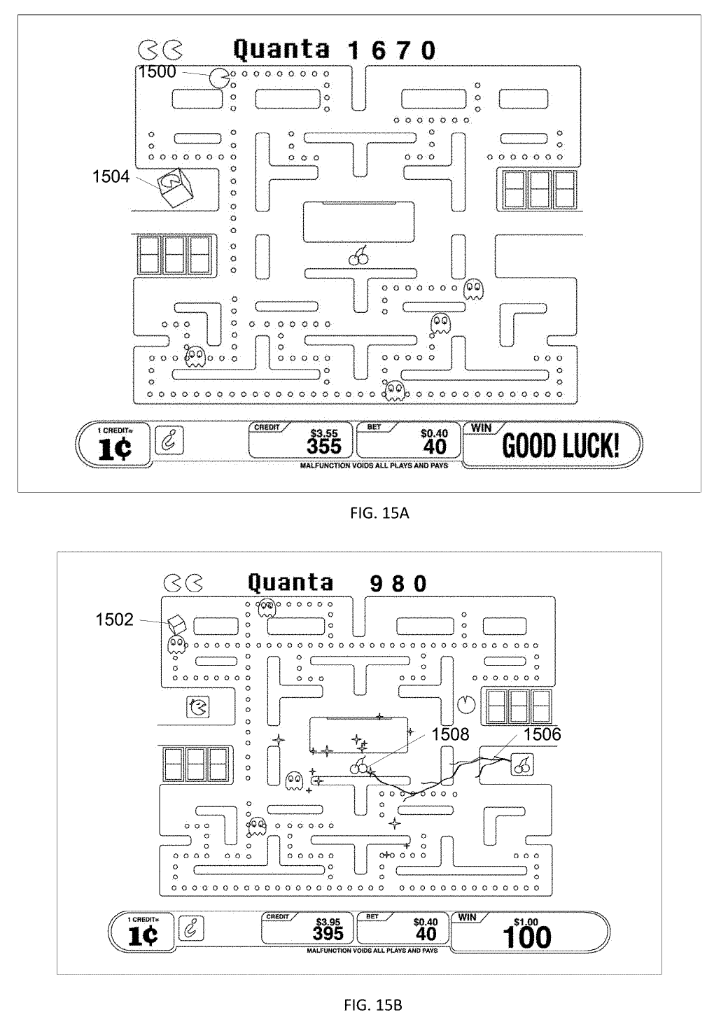

FIGS. 15A and 15B depict a display for a user interface for a maze chase hybrid game system in accordance with some embodiments of the invention. The user interface illustrates the actions of a random event initiated by consumption of an icon by a controlled entity that provides a random outcome in the form of an in-game object. In operation, a controlled entity 1500 consumes an icon (such as icon 1502) indicating a random event having a random outcome in the form of an in-game object may be initiated or triggered through consumption by the controlled entity. In the case the maze chase hybrid game system determines that the icon is consumed, they maze chase hybrid game system initiates the random event and a random event process indicator 1504 is displayed to the player. The random event process indicator provides a visual indication to the player that a random event has been initiated and is currently in process. When the event processing is over, a random event outcome indicator 1506 is displayed to the player indicating that the event has been processed and then an indicator 1508 of an in-game object awarded to the player as an outcome of the random event is displayed to the player. Examples of in-game objects for a maze chase hybrid game system include, but are not limited to: power ups providing special properties to the controlled entity; additional lives for the controlled entity; and additional virtual credits or game world credits.

In some embodiments, the random event initiated by consumption of the icon by the controlled entity that provides the random outcome in the form of an in-game object also includes a wager of game world credits or virtual credits in order to obtain the random outcome in the form of an in-game object.

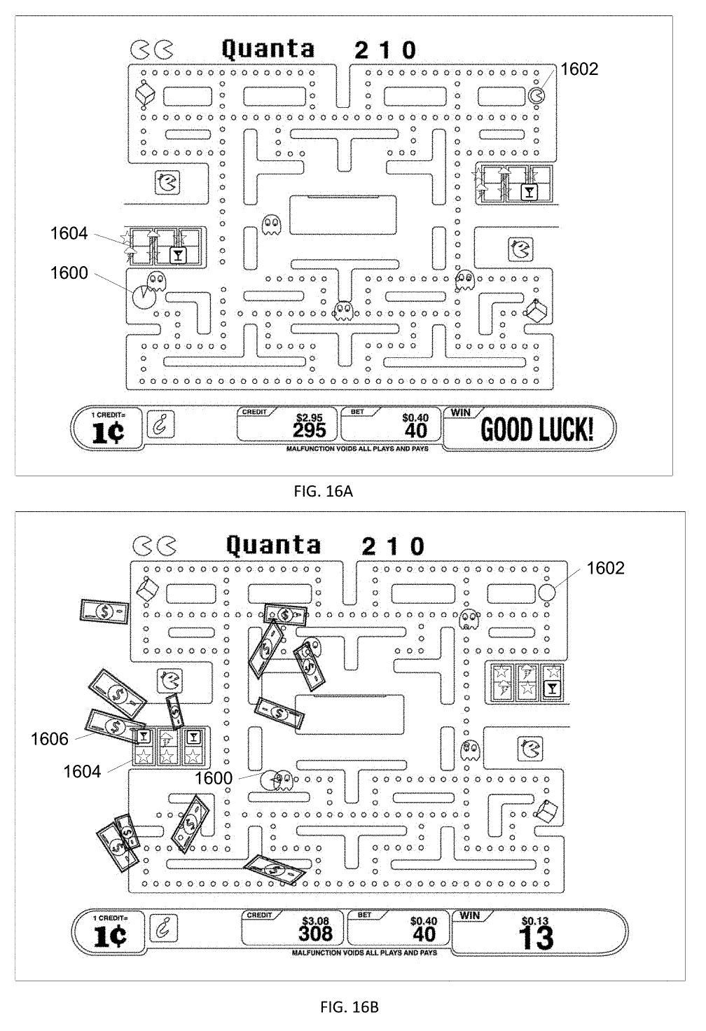

FIGS. 16A and 16B depict a display for a user interface for a maze chase hybrid game system in accordance with some embodiments of the invention. The user interface illustrates the actions of a random event initiated by consumption of an icon by a controlled entity that includes a wager of real credits and provides a random outcome in the form of real credits. In operation, a controlled entity 1600 consumes an icon (such as icon 1602) indicating a random event having a random outcome in the form of real credits and having a wager of real credits is initiated or triggered through consumption of the icon by the controlled entity. In the case the maze chase hybrid game system determines that the icon is consumed, they maze chase hybrid game system initiates the random event and a random event process indicator 1604 is displayed to the player. The random event process indicator provides a visual indication to the player that a random event has been initiated and is currently in process. Once the event processing is over, a random event outcome indicator 1606 is displayed to the player indicating that the event has been processed and then an indicator 1608 of real credits awarded to the player as an outcome of the random event is displayed to the player.

In some embodiments, a random event process indicator for an event that results in a random outcome of in-game objects and a random event process indicator for an event that results in a random outcome of real credits differ in physical representation or appearance. In one embodiment, the random event process indicator for an event that results in a random outcome of in-game objects has the physical representation and appearance of a die or a cube, and the random event process indicator for an event that results in a random outcome of real credits has the physical representation and appearance of reels on a slot machine.

In many embodiments, a random event outcome indicator for an event that results in a random outcome of in-game objects and a random event outcome indicator for an event that results in a random outcome of real credits differ in physical representation or appearance. In one embodiment, the random event outcome indicator for an event that results in a random outcome of in-game objects has the physical representation and appearance of lightning bolts or electrical arcs, and the random event outcome indicator for an event that results in a random outcome of real credits has the physical representation and appearance of currency in the form of bills or coins.

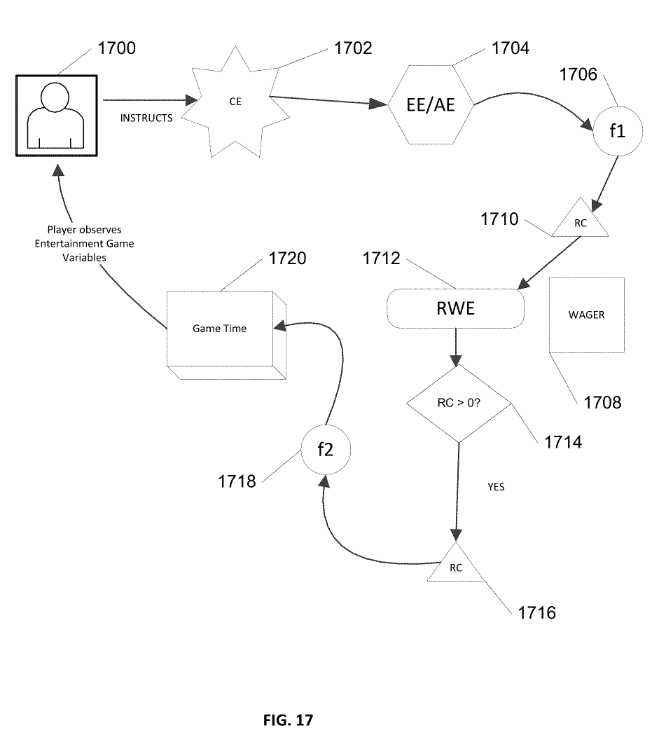

FIG. 17 is a process flow diagram of a process of wagering in a maze chase hybrid game system in accordance with some embodiments of the invention. In operation, a player 1700 instructs a controlled entity 1702 to consume or use an enabling element (EE) or an actionable element (AE) 1704 as described herein. When the maze chase hybrid game system determines that the EE or AE has been consumed, the utilization of the element triggers (by function 1706) a wager 1708 of real credit (RC) 1710 in a gambling game of a real world engine (RWE) 1712. Based on the gambling game outcome (1714) RC 1716 is awarded to the player. In addition, the gambling outcome is used to determine (as indicated by function 1718) additional EE/AE (such as, but not limited to game time 1720) that is awarded to the player.

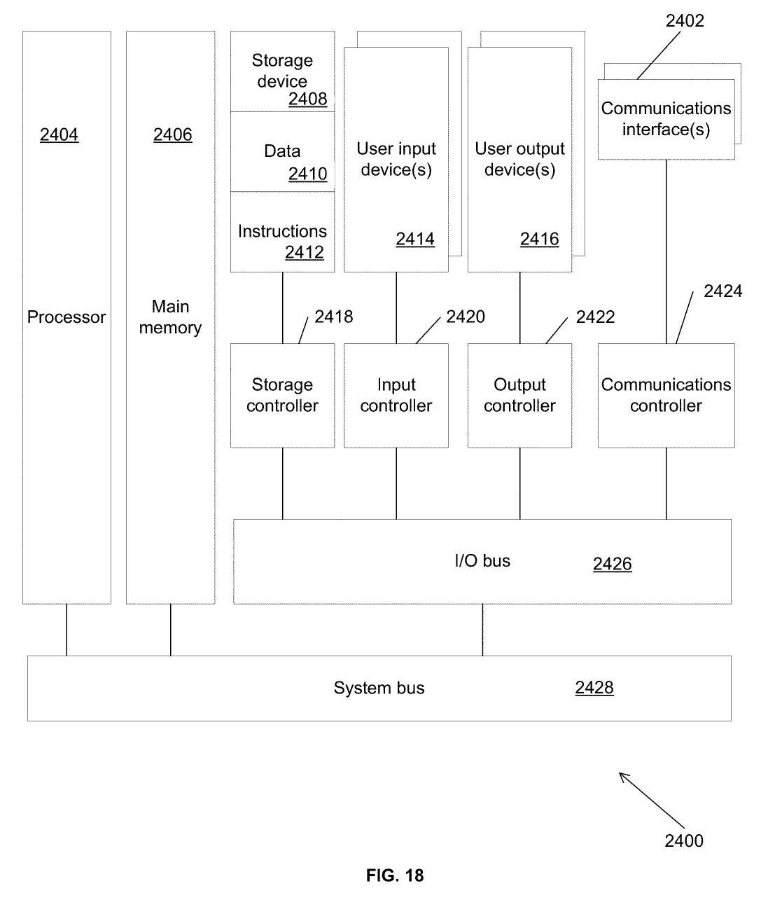

Any of a variety of processing apparatuses can host various components of a maze chase hybrid game system in accordance with embodiments of the invention. In accordance with embodiments of the invention, these processing apparatuses can include, but are not limited to, tablet computers, mobile devices such as a smartphone, a hand-held gaming machine, a gaming console, a gambling gaming machine, a general purpose computer, a computing device and/or a controller. A processing apparatus that is constructed to implement a maze chase hybrid game system in accordance with embodiments of the invention is illustrated in FIG. 18. In the processing apparatus 2400, a processor 2404 is coupled to a memory 2406 by a bus 2428. The processor 2404 is also coupled to non-transitory processor-readable storage media, such as a storage device 2408 that stores processor-executable instructions 2412 and data 2410 through the system bus 2428 to an I/O bus 2426 through a storage controller 2418. The processor 2404 is also coupled to one or more interfaces that can be used to connect the processor to other processing apparatuses as well as networks as described herein. The processor 2404 is also coupled via the bus to user input devices 2414, such as tactile devices including, but not limited to, keyboards, keypads, foot pads, touch screens, and/or trackballs; as well as non-contact devices such as audio input devices, motion sensors and motion capture devices that the processing apparatus can use to receive inputs from a user when the user interacts with the processing apparatus. The processor 2404 is connected to these user input devices 2414 through the system bus 2428, to the I/O bus 2426 and through the input controller 2420. The processor 2404 is also coupled via the bus to user output devices 2416 such as (but not limited to) visual output devices, audio output devices, and/or tactile output devices that the processing apparatus uses to generate outputs perceivable by the user when the user interacts with the processing apparatus. In accordance with some embodiments, the processor is coupled to visual output devices such as (but not limited to) display screens, light panels, and/or lighted displays. In accordance with particular embodiments, the processor is coupled to audio output devices such as (but not limited to) speakers, and/or sound amplifiers. In accordance with many of these embodiments, the processor 2404 is coupled to tactile output devices like vibrators, and/or manipulators. The processor 2404 is connected to output devices from the system bus 2428 to the I/O bus 2426 and through the output controller 2422. The processor 2404 can also be connected to a communications interface 2402 from the system bus 2428 to the I/O bus 2426 through a communications controller 2424.

In accordance with various embodiments, a processor 2404 can load instructions and data from the storage device into the memory 2406. The processor 2404 can also execute instructions that operate on the data to implement various aspects and features of the components of a maze chase hybrid game system as described herein. The processor 2404 can utilize various input and output devices in accordance with the instructions and the data in order to create and operate user interfaces for players or operators of a maze chase hybrid game system(such as but not limited to a casino that hosts the maze chase hybrid game system).

Although the processing apparatus 2400 is described herein as being constructed from a processor and instructions stored and executed by hardware components, the processing apparatus can be composed of only hardware components in accordance with other embodiments. In addition, although the storage device is described as being coupled to the processor through a bus, those skilled in the art of processing apparatuses will understand that the storage device can include removable media such as, but not limited to, a USB memory device, an optical CD ROM, magnetic media such as tape and disks. Also, the storage device can be accessed by processor 2404 through one of the interfaces or over a network. Furthermore, any of the user input devices or user output devices can be coupled to the processor 2404 via one of the interfaces or over a network. In addition, although a single processor 2404 is described, those skilled in the art will understand that the processor 2404 can be a controller or other computing device or a separate computer as well as be composed of multiple processors or computing devices.

It should also be understood that a hybrid gaming device as described herein can be implemented on multiple processing apparatuses, whether dedicated, shared or distributed in any combination thereof, or may be implemented on a single processing apparatus.

To the extent that a maze chase hybrid game system utilizes networks, connections and interfaces as herein described, it would be apparent to those skilled in the art that such networks, connections and interfaces could be any combination of the internet, a LAN, optical or wireless networks or any other method for connecting computer devices, and any applicable protocols and data interchange methods routinely practiced for such purposes.

Although certain specific features and embodiments of a gaming system have been described herein, many additional modifications and variations would be apparent to those skilled in the art. For example, the features and embodiments described herein may be implemented independently, cooperatively or alternatively without deviating from the spirit of the disclosure. It is therefore to be understood that gaming system may be practiced otherwise than as specifically described. Thus, the foregoing description of the gaming system should be considered in all respects as illustrative and not restrictive, the scope of the claims to be determined as supported by this disclosure and the claims' equivalents, rather than the foregoing description.

What is claimed is:

1. A gaming system for a hybrid maze chase game, comprising:
an entertainment system engine connected to a game world engine, wherein the entertainment software engine is constructed to:
provide a skill-based entertainment game to a player;
generate a visual display of the entertainment game including a user interface;
display a first icon in the user interface of the entertainment game;
communicate, to a game world engine, an indication when the first icon is consumed by a controlled entity during the entertainment game, wherein the first icon consumption initiates a wager of real credits;
receive, from the game world engine, a wager outcome of real credits;
update the visual display of the entertainment game to include the wager outcome;
generate, in the entertainment game, a first set of in-game objects associated with the wager outcome;
display a second icon, different in appearance from the first icon, in the user interface of the entertainment game;
communicate, to the game world engine, an indication when the second icon is consumed by the controlled entity during the entertainment game, wherein the second icon consumption initiates a random outcome;
receive, from the game world engine, the random outcome;
update the visual display of the entertainment game to include the random outcome; and
generate, in the entertainment game, a second set of in-game objects associated with the random outcome;
the real world engine connected to the game world engine, wherein the real world engine includes a random number generator and is constructed to:
receive, from the game world engine, the wager of real credits;
generate the wager outcome of real credits using the random number generator; and
communicate, to the game world engine, the wager outcome; and
the game world engine connected to the entertainment system engine and the real world engine constructed to:
receive, from the entertainment system engine, the indication when the first icon is consumed;
communicate, to the real world engine, the wager of real credits;
receive, from the real world engine, the wager outcome;
determine the first set of in-game objects for the entertainment game associated with the wager outcome;
communicate, to the entertainment system engine, the first set of in-game objects for the entertainment game associated with the wager outcome;
receive, from the entertainment system engine, the indication when the second icon is consumed;
generate the random outcome;
determine the second set of in-game objects for the entertainment game associated with the random outcome; and
communicate, to the entertainment system engine, the second set of in-game objects for the entertainment game associated with the random outcome.

2. The gaming system for a hybrid maze chase game of claim 1, wherein the entertainment system engine is further constructed to:
display a first random event process indicator in the user interface of the entertainment game when the first icon is consumed by the controlled entity; and
display a second random event process indicator in the user interface of the entertainment game when the second icon is consumed by the controlled entity, wherein the first random event process indicator and the second random event process indicator are different in appearance.

3. The gaming system for a hybrid maze chase game of claim 1, wherein the entertainment system engine is further constructed to:
display a first random event outcome indicator in the user interface of entertainment game when the first icon is consumed by the controlled entity; and
display a second random event outcome indicator in the user interface of the entertainment game when the second icon is consumed by the controlled entity,
wherein the first random event outcome indicator and the second random event outcome indicator are different in appearance.

4. The gaming system for a hybrid maze chase game of claim 1, wherein initiating the random outcome also initiates a wager of game world credits.

5. The gaming system for a hybrid maze chase game of claim 1, wherein game world credit is awarded as a function of performance in the entertainment game.

6. The gaming system for a hybrid maze chase game of claim 1, wherein initiating the wager further includes determining the amount of real credit committed to the wager.

7. The gaming system for a hybrid maze chase game of claim 1, wherein the in-game objects provide additional opportunities to control the controlled entity.

8. The gaming system for a hybrid maze chase game of claim 1, wherein the entertainment software engine, the real world engine, and the game world engine are constructed from a singe device.

9. The gaming system for a hybrid maze chase game of claim 1, wherein the entertainment software engine, the real world engine, and the game world engine are constructed from a plurality of devices.

10. A gaming system for a hybrid maze chase game, comprising:
a processor;
a random number generator; and
a memory connected to the processor, wherein the memory stores executable instructions that when executed by the processor cause the processor to:
provide a skill-based entertainment game to a player;
generate a visual display of the entertainment game including a user interface;
display a first icon in the user interface of the entertainment game;
determine when the first icon is consumed by a controlled entity during the entertainment game, wherein the first icon consumption initiates a wager of real credits;
determine a wager outcome of real credits for the wager of real credits using the random number generator;
update the visual display of the entertainment game to include the wager outcome;
generate, in the entertainment game, a first set of in-game objects associated with the wager outcome;
display a second icon, different in appearance from the first icon, in the user interface of the entertainment game;
determine when the second icon is consumed by the controlled entity during the entertainment game, wherein the second icon consumption initiates a random outcome;
update the visual display of the entertainment game to include the random outcome; and
generate, in the entertainment game, a second set of in-game objects associated with the random outcome.

11. The gaming system for a hybrid maze chase game of claim 10, wherein instructions when executed by the processor further cause the processor to:
display a first random event process indicator in the user interface of the entertainment game when the first icon is consumed by the controlled entity; and
display a second random event process indicator in the user interface of the entertainment game when the second icon is consumed by the controlled entity, wherein the first random event process indicator and the second random event process indicator are different in appearance.

12. The gaming system for a hybrid maze chase game of claim 1, wherein instructions when executed by the processor further cause the processor to:
display a first random event outcome indicator in the user interface of entertainment game when the first icon is consumed by the controlled entity; and
display a second random event outcome indicator in the user interface of the entertainment game when the second icon is consumed by the controlled entity,
wherein the first random event outcome indicator and the second random event outcome indicator are different in appearance.

13. The gaming system for a hybrid maze chase game of claim 1, wherein initiating the random outcome also initiates a wager of game world credits.

14. The gaming system for a hybrid maze chase game of claim 10, wherein game world credit is awarded as a function of performance in the entertainment game.

15. The gaming system for a hybrid maze chase game of claim 10, wherein initiating the wager further includes determining the amount of real credit committed to the wager.

16. The gaming system for a hybrid maze chase game of claim 10, wherein the in-game objects provide additional opportunities to control the controlled entity.
